(19) United States
(12) Patent Application Publication
(10) Pub. No.: US 2002/0165916 A1
(43) Pub. Date: Nov. 7, 2002

(54) Method of providing information

(76) Inventor: Katsutoshi Kitamura, Niiza-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/138,431

(22) Filed: May 6, 2002

(30) Foreign Application Priority Data
Nov. 30, 2001 (JP) 2001-367841
May 7, 2001 (JP) PCT/JP01/03823

(51) Int. Cl. G06F 15/16

(52) U.S. Cl. 709/203

(57) ABSTRACT

A plurality of sets of group information are stored in an information-providing server 10 with access identification information comprising an information code which differs for each piece of unit information and an electronic mail address used when requesting unit information functioning as search key information. These information codes and the electronic mail address are disclosed in a display transmission medium displaying transmission information comprising any one of a list, an outline, or a portion of the corresponding unit information. When a user sends an electronic mail incorporating an aforementioned information code to the aforementioned information-providing server using the aforementioned electronic mail address, the corresponding unit information is provided from the information-providing server to the user.

### DETAILED DESCRIPTION OF THE INVENTION

1. Field of the Invention

The present invention relates to a method of providing information wherein an electronic mail function of a device such as a mobile telephone with an internet browser, a PDA (a portable information terminal) or a personal computer is used and enables information to be acquired with ease from an information-providing server.

2. Description of the Related Art

In cases where, for example, an attempt is made to acquire real estate item information, service information and counter information from administrative bodies, second hand vehicles sales information, employment information, or various merchandise sales information and the like, via the internet, using an information access terminal such as a mobile telephone or the like, then following access to the information-providing server, on which a large volume of information is stored, the user needs to keep repeating a complex operation in order to extract the desired information.

For example, in the case of rental property item information, selections and executions must be made across the following 7 hierarchical levels. Namely, following access to the information-providing server, the user must progress through a sequence comprising (1) country block selection, (2) prefecture selection, (3) railway line selection, (4) station selection, (5) desired floor plan selection, (6) desired rental cost selection, and (7) list display of information items, in order to display the targeted rental property items and acquire the necessary information.

The above type of sequence requiring a plurality of selections and decisions is in itself complicated, and moreover repeating such operations using the small and limited number of keys of a small mobile telephone while looking at a small display screen is extremely difficult, and the prevalence of operational mistakes such as the pressing of a wrong key are a problem.

Furthermore, when a user sends electronic mail to an information-providing server using a mobile telephone or the like, then usually the information-providing server is able to acquire the electronic mail address of the user. Then, such acquired electronic mail addresses can be used for finding customers, or specifying or enclosing certain users. However, if a complicated sequence such as that described above is required, then another problem arises in that the number of users will decrease.

### SUMMARY OF THE INVENTION

Consequently, if the information to be provided is offered via a predetermined code, and the user is required to carry out requests using such codes, then an environment can be provided where direct access is possible without passage through a deep hierarchy, and requests can be made which use only number codes and make the most of the properties of the ten keys, thereby enabling the aforementioned problems to be resolved. In cases where a code concept is used, which information corresponds with which code needs to be clearly displayed, although this problem can be resolved in conjunction with other media (printed media, media using radio wave). Furthermore, from the viewpoint of the information provider, it is desirable that the user leaves a trail. Consequently, a structure is adopted where the electronic mail function installed on an internet compatible portable information terminal is used, and matching is conducted with the group information on the server, and an automatic reply then sent. In-other words, an invention is provided which combines a server and the electronic mail function of an internet compatible portable information terminal with another medium (printed, electromagnetic waves).

An object of this invention is to provide a method of providing information, wherein a user who accesses an information-providing server from an information access terminal such as a mobile telephone can be provided with certain target information based on a simple operation performed by the user.

Furthermore, another object of the invention is to provide a method of providing information which improves convenience for the user, promotes an increase in the number of users, and enables the acquisition of electronic mail addresses for a plurality of users.

Recently, by using a mobile telephone, users have been able to find details such as the location and operating hours for certain target service shops such as restaurants, shops, businesses, and hairdressers for men and women. In addition, at the same time, users have also been able to use a mobile telephone to obtain detailed information relating to rental property items for example.

In such cases, it is convenient if the source of such detailed information can be accessed from the site of the targeted restaurant or property.

Another object of this invention is to provide a method of providing information, wherein in the above types of cases, information can be easily obtained from the site of the restaurant or property or the like.

The present invention achieves the above object by providing a method of providing information, wherein group information comprising a plurality of pieces of unit information is registered in advance in an information-providing server, with access identification information for individually specifying and requesting such unit information for supply for perusal by a user functioning as search key information, and moreover the aforementioned access identification information comprises either one of an electronic mail address which functions as an electronic mail destination from the user and an information code which differs for each of the aforementioned pieces of unit information, or an electronic mail address which incorporates the information code, and the access identification information is disclosed on a display transmission medium displaying any one of a list, an outline, or a portion of the corresponding unit information, and recognition of the aforementioned access identification information is promoted to the user reading the aforementioned transmission information and requesting the corresponding unit information, and moreover when the user sends an electronic mail incorporating the information code specifying requested unit information to the information-providing server at the electronic mail address corresponding with the requested unit information, the electronic mail address of the source of that electronic mail transmission is acquired from the electronic mail together with the specified information code.

Further, the present invention achieves the above objective by providing a method of providing information, wherein group information comprising a plurality of pieces of unit information is registered in advance in an information-providing server, with access identification information for individually specifying and requesting such unit information for supply for perusal by a user functioning as search key information, and moreover the aforementioned access identification information comprises either one of an electronic mail address which functions as an electronic mail destination from the user and an information code which differs for each of the aforementioned pieces of unit information, or an electronic mail address which incorporates the information code, and the access identification information is disclosed on a display transmission medium displaying any one of a list, an outline, or a portion of the corresponding unit information, and recognition of the aforementioned access identification information is promoted to the user reading the aforementioned transmission information and requesting the corresponding unit information, and moreover when the user sends an electronic mail incorporating the information code specifying requested unit information to the information-providing server at the electronic mail address corresponding with the requested unit information, the unit information corresponding with the access identification information comprising this electronic mail address and this information code is provided from the aforementioned information-providing server to the user via an electronic mail reply to the electronic mail source address acquired from the electronic mail sent by the user.

Furthermore, a plurality of different access identification information may also be set for each single piece of unit information, and this plurality of different access identification information then disclosed separately via a plurality of different display transmission media, and also registered in the aforementioned information-providing server as search key information.

In addition, the results from the unit information request from the user using the aforementioned access identification information may also be detected for each access identification information.

Moreover, the aforementioned plurality of different access identification information could be allocated to, and disclosed using each type of the aforementioned display transmission media, and the results from the unit information requests from users then detected for each type of display transmission medium.

Furthermore, an advertising fee could also be calculated based on the results of the requests from users detected for each of the aforementioned access identification information.

In addition, the aforementioned display transmission medium may comprise at least one of a portable printed card medium, an electromagnetic wave medium, a publication medium, and a printed notice medium.

Moreover, the aforementioned information code may comprise at least one of a campaign code, a coupon participation code, a survey code, a commercial code, an address code, a company code, a map code, a telephone number, a postal number, and a G code.

Moreover, information for specifying the user included in header information of the electronic mail sent from the user may be extracted and used in the information-providing server.

Moreover, time information included in the electronic mail sent from the user may be extracted and used in the information-providing server.

Moreover, the aforementioned information code may be entered in a subject or a body section of the electronic mail sent from the user, and a special character that is assigned a special function may immediately follow the information code.

Moreover, a plurality of the information codes may be entered in a subject or in a body section of the electronic mail sent from the user with a predetermined divisional character placed between the plurality of information codes.

Moreover, a reply user code may be attached to the aforementioned unit information that is provided to the user via an electronic mail reply. The reply user code differs for each electronic mail reply.

Moreover, the electronic mail sent by the user to the information-providing server as well as the electronic mail reply thereto may be directly transmitted without using the internet.

The present invention achieves the above object by comprising an information-providing server wherein group information comprising a plurality of pieces of unit information is registered in advance in the information-providing server with access identification information for individually specifying and requesting such unit information for supply for perusal by a user functioning as search key information, and moreover the aforementioned access identification information comprises either one of an electronic mail address which functions as an electronic mail destination from the user and an information code which differs for each of the aforementioned pieces of unit information, or an electronic mail address which incorporates the information code, and which upon receipt of an electronic mail from a user incorporating the information code specifying the requested unit information, via the electronic mail address corresponding with the requested unit information, acquires from the electronic mail the electronic mail address of the source of the electronic mail together with the specified information code, and a display transmission medium for disclosing the aforementioned access identification information together with a display of transmission information comprising any one of a list, an outline, or a portion of the corresponding unit information, and promoting recognition of the aforementioned access identification information to a user reading the transmission information and requesting the corresponding unit information.

The present invention achieves the above object by comprising an information-providing server wherein group information comprising a plurality of pieces of unit information is registered in advance in the information-providing server with access identification information for individually specifying and requesting such unit information for supply for perusal by a user functioning as search key information, and moreover the aforementioned access identification information comprises either one of an electronic mail address-which functions as an electronic mail destination from the user and an information code which differs for each of the aforementioned pieces of unit information, or an electronic mail address which incorporates the information code, and which upon receipt of an electronic mail from a user incorporating the information code specifying the requested unit information, via the electronic mail address corresponding with the requested unit information, provides unit information corresponding with the access identification information comprising this electronic mail address and information code to the user via an electronic mail reply to the electronic mail source address acquired from the electronic mail sent by the user, and a display transmission medium for disclosing the aforementioned access identification information together with a display of transmission information comprising any one of a list, an outline, or a portion of the corresponding unit information, and promoting recognition of the aforementioned access identification information to a user reading the transmission information and requesting the corresponding unit information.

The present invention achieves the above object by providing an information providing server comprising an information-providing database wherein group information comprising a plurality of pieces of unit information is registered in advance in an information-providing server with access identification information for individually specifying and requesting such unit information for supply for perusal by a user functioning as search key information, and moreover the aforementioned access identification information comprises either one of an electronic mail address which functions as an electronic mail destination from the user and an information code which differs for each of the aforementioned pieces of unit information, or an electronic mail address which incorporates the information code, and an information exchange processing control device which upon receipt from a user, via the electronic mail address corresponding with a requested unit information, of an electronic mail incorporating the information code specifying the requested unit information, provides unit information corresponding with the access identification information comprising this electronic mail address and the information code to the user via an electronic mail reply to the electronic mail source address acquired from the electronic mail sent by the user.

The present invention achieves the above object by providing a portable printed card medium, wherein of the group information comprising a plurality of pieces of unit information for supply for perusal by a user, access identification information comprising either an electronic mail address which functions as an electronic mail destination for individually specifying and requesting a required unit information and an information code which differs for each piece of unit information, or an electronic mail address which incorporates the information code, is disclosed and printed in a display of transmission information comprising a list, or an outline, or a portion of the corresponding unit information, and moreover at least a portion of explanatory information for sending an electronic mail requesting desired unit information based on the aforementioned access identification information is printed, and used for promoting recognition of the aforementioned access identification information to the user reading the transmission information and requesting the corresponding unit information.

In this invention, group information comprising a plurality of pieces of unit information is registered in advance in an information-providing server, with access identification information for individually specifying and requesting such unit information for supply for perusal by a user, and comprising either an electronic mail address which functions as an electronic mail destination from the user and an information code which differs for each of the aforementioned pieces of unit information, or an electronic mail address which incorporates the information code, functioning as search key information. Furthermore, the aforementioned access identification information is disclosed via a display transmission medium displaying transmission information comprising a list, or an outline, or a portion of the corresponding unit information. In this way, recognition of the aforementioned access identification information is promoted to a user who reads this transmission information and requests the corresponding unit information.

In this manner, when the aforementioned user sends an electronic mail incorporating the information code specifying the requested unit information to the information-providing server at the aforementioned electronic mail address corresponding with the requested unit information, the electronic mail address showing the source of the electronic mail can be acquired from the electronic mail together with the specified information code.

Alternatively, in this manner, when the aforementioned user sends an electronic mail incorporating the information code specifying the requested unit information to the information-providing server at the aforementioned electronic mail address corresponding with the requested unit information, the unit information corresponding with the access identification information comprising this electronic mail address and the information code can be provided from the aforementioned information-providing server to the user via an electronic mail reply to the electronic mail source address acquired from the electronic mail sent by the user.

### BRIEF DESCRIPTION OF THE DRAWINGS

FIG. 1 is a block diagram showing the construction of a device for implementing a method of providing information according to a sample embodiment of the present invention;

FIG. 2 is a block diagram showing the construction of an information-providing server 10 of the aforementioned embodiment;

FIG. 3 is a flowchart showing processing of the aforementioned embodiment;

FIG. 4 is a diagram showing the disclosed form of access identification information in a first example within the aforementioned embodiment;

FIG. 5 is a first diagram showing the disclosed form of access identification information in a second example within the aforementioned embodiment;

FIG. 6 is a second diagram showing the disclosed form of access identification information in the second example, within the aforementioned embodiment;

FIG. 7 is a third diagram showing the disclosed form of access identification information in the second example within the aforementioned embodiment;

FIG. 8 is a diagram showing a first form for card folding within the aforementioned embodiment;

FIG. 9 is a diagram showing a second form for card folding within the aforementioned embodiment;

FIG. 10 is a diagram showing the disclosed form of access identification information in a third example within the aforementioned embodiment;

FIG. 11 is an enlarged diagram of the left side of the disclosed form of access identification information in the third example within the aforementioned embodiment;

FIG. 12 is an enlarged diagram of the central portion of the disclosed form of access identification information in the third example within the aforementioned embodiment;

FIG. 13 is an enlarged diagram of the right side of the disclosed form of access identification information in the third example within the aforementioned embodiment;

FIG. 14 is a diagram showing the disclosed form of access identification information in a fourth example within the aforementioned embodiment, assuming a television broadcast;

FIG. 15 is a diagram showing the disclosed form of access identification information in a fifth example within the aforementioned embodiment, assuming a television broadcast;

FIG. 16 is a first diagram showing the disclosed form of access identification information in a sixth example within the aforementioned embodiment;

FIG. 17 is a second diagram showing the disclosed form of access identification information in the sixth example within the aforementioned embodiment;

FIG. 18 is a diagram showing the disclosed form of access identification information in a seventh example of the present invention;

FIG. 19 is a diagram showing information codes in an eighth example of the aforementioned embodiment;

FIG. 20 is a diagram showing one example of electronic mail entry incorporating the information code in the eighth example;

FIG. 21 is a diagram showing one example of header information in electronic text of the electronic mail in the eighth example;

FIG. 22 is a diagram showing information codes in a ninth example of the aforementioned embodiment;

FIG. 23 is a diagram showing one example of electronic mail entry in the ninth example;

FIG. 24 is a diagram showing one example of electronic mail entry incorporating an information code in a tenth example of the aforementioned embodiment;

FIG. 25 is a diagram showing one example of the manner in which unit information is displayed in an eleventh example of the aforementioned embodiment;

FIG. 26 is a diagram showing the disclosed form of information codes in a twelfth example of the aforementioned embodiment;

FIG. 27 is a diagram showing one example of electronic mail entry incorporating the information code in the twelfth example;

FIG. 28 is a diagram showing one example of electronic mail entry in a thirteenth example of the aforementioned embodiment;

FIG. 29 is diagram showing a first example of electronic mail entry incorporating the information code in the thirteenth example;

FIG. 30 is a diagram showing a second example of electronic mail entry incorporating the information code in the thirteenth example;

FIG. 31 is a diagram showing a third example of electronic mail entry incorporating the information code in the thirteenth example;

FIG. 32 is a diagram showing a fourth example of electronic mail entry incorporating the information code in the thirteenth example; and

FIG. 33 is a diagram showing a fifth example of electronic mail entry incorporating the information code in the thirteenth example.

### DETAILED DESCRIPTION OF THE PREFERRED EMBODIMENTS

As follows is a detailed description of a sample embodiment of the present invention, with reference to the drawings.

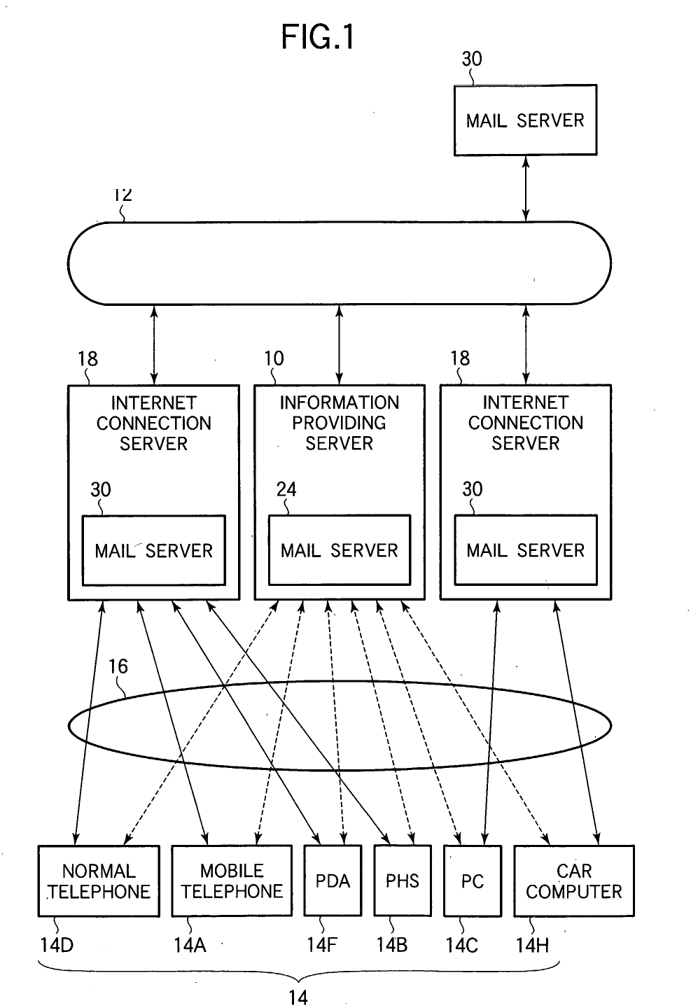

FIG. 1 is a block diagram showing the construction of a device for implementing a method of providing information according to a sample embodiment of the present invention.

In FIG. 1, an information-providing server 10 belonging to an information provider is connected to the internet 12.

In contrast, the various information access terminals which are used by a user 1 for acquiring targeted information from the information-providing server 10 and which function as objects of the present embodiment include, for example, a mobile telephone 14A and a PHS 14B equipped with electronic mail functions, a portable compact personal computer (hereafter referred to as a PC) 14C, a normal telephone equipped with an electronic mail function 14D, a portable information terminal (PDA: personal data assistant) 14F, and a car mounted computer (car navigation system) 14H. Hereafter these various information access terminals are referred to as information terminals 14.

These information terminals 14 are able to use electronic mail utilizing the internet 12, either via a mail server 30 provided within an internet connection server 18 connected directly via a wireless connection or a wired public telephone line (or a dedicated line) 16 (hereafter referred to as a public line 16), or via an internet connection server 18 connected directly via a public line 16 and a mail server 30 to which a connection is made via the internet 12. Furthermore, this electronic mail can also be sent to a mail server 24 using the mail server 30.

In addition, in the case where an information terminal 14 uses the mail server 30 within the information-providing server 10, a direct connection is made to the information-providing server 10, and electronic mail utilizing the internet 12 is used. In such a case, electronic mail can also be sent from the mail server 30 to the mail server 24, within the information-providing server 10.

According to the present embodiment, by using electronic mail, it is possible to exchange information with the information-providing server 10 which is connected directly to the internet 12. In other words, electronic mail is exchanged with the mail server 24 within the information-providing server 10, enabling the requesting of unit information of the present invention, and the provision of that unit information.

The information terminal 14 such as a mobile telephone 14A or the like comprises an input device such as a dial button or a keyboard and a display device such as a liquid crystal display or the like, and by carrying out electronic mail exchange according to the present invention with the information-providing server 10 via the internet 12, is able to display on the aforementioned display device, targeted unit information from amongst the large volume of information (group information) stored on the information-providing server 10.

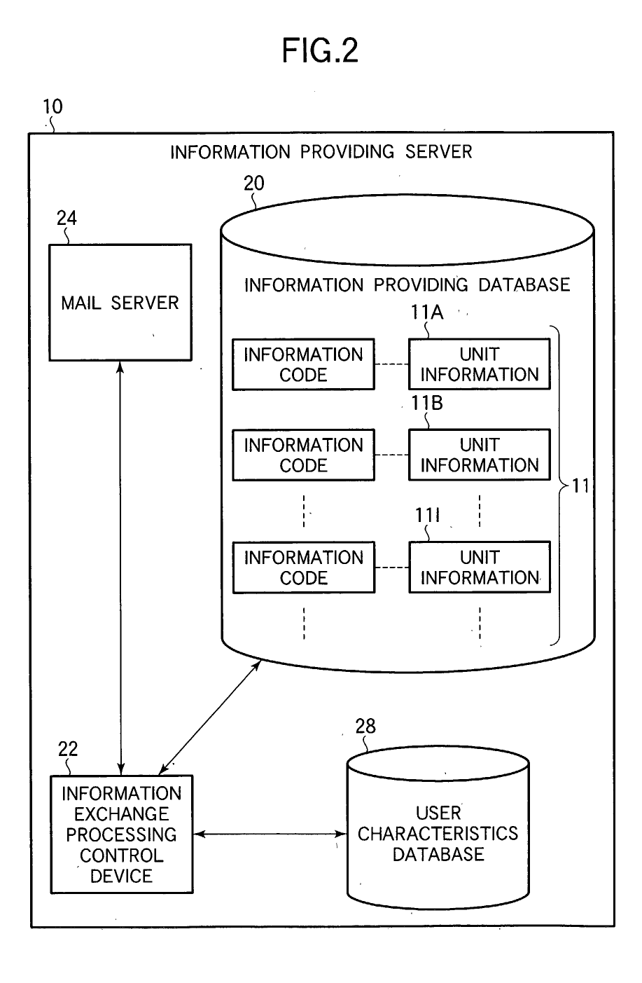

FIG. 2 is a block diagram showing the construction of the information-providing server 10 of the present embodiment.

As shown in the diagram, the information-providing server 10 comprises an information-providing database 20 in which is stored a plurality of pieces of unit information 11A, 11B . . . 11I . . . (hereafter jointly referred to as unit information 11), an information exchange processing control device 22, a mail server 24, and a user characteristics database 28.

First, the information-providing database 20 registers in advance, group information comprising a, plurality of pieces of unit information, with access identification information for individually specifying and requesting such unit information for supply for perusal by the user 1, and comprising an electronic mail address which functions as an electronic mail destination from the user and an information code which differs for each of the aforementioned pieces of unit information, functioning as search key information. As described below, the access identification information may also be configured so that the information code is incorporated within a portion of the electronic mail address.

Furthermore, in cases where no particular unit information is requested, but where the user 1 participates in the type of subscription described below based on transmission information, or furthermore in those cases where, as necessary, the user requests a piece of unit information based on the transmission information, then upon receipt of an electronic mail from the user 1 incorporating the information code specifying certain requested unit-information, via the electronic mail address corresponding with that requested unit information, the information exchange processing control device 22 acquires the electronic mail address showing the source of the electronic mail, together with the specified information code, from the received electronic mail. The electronic mail address and the information code acquired from the electronic mail, and furthermore any other information acquired from the electronic mail, is information which relates to the user 1, and is stored in the user characteristics database 28. The information stored in this type of user characteristics database 28 can be used in subsequent business undertakings such as marketing and the like, as described below.

Alternatively, in those cases where based on the transmission information the user 1 requests specific unit information, then upon receipt of an electronic mail from the user 1 incorporating the information code specifying the requested unit information, via the electronic mail address corresponding with the requested unit information, the information exchange processing control device 22 provides the unit information corresponding with the access identification information comprising this electronic mail address and this information code to the user 1, via an electronic mail reply to the electronic mail source address acquired from the electronic mail sent by the user.

Moreover, during this type of electronic mail exchange with the user 1 by the information exchange processing control device 22, the mail server function of the information-providing server 10 is provided by the mail server 24.

Moreover as described above, according to the present embodiment, the access identification information is used as search key information, unit information is stored in the information-providing database 20, and the information exchange processing control device 22 reads out this type of stored unit information. In other words, the electronic mail address and the information code which make up the access identification information are used as the search key information.

In those cases where the information-providing server 10 has only a single electronic mail address, the storage of unit information in the information-providing database 20 and the reading of such stored unit information by the information exchange processing control device 22 with only the information code as the search key information, is effectively the same as using the access identification information comprising both the electronic mail address and the information code as the search key information.

Furthermore, in those cases where the information code makes up a portion of the electronic mail address, then a number of electronic mail addresses equal to the number of information codes, namely the number of pieces of unit information, need to be prepared.

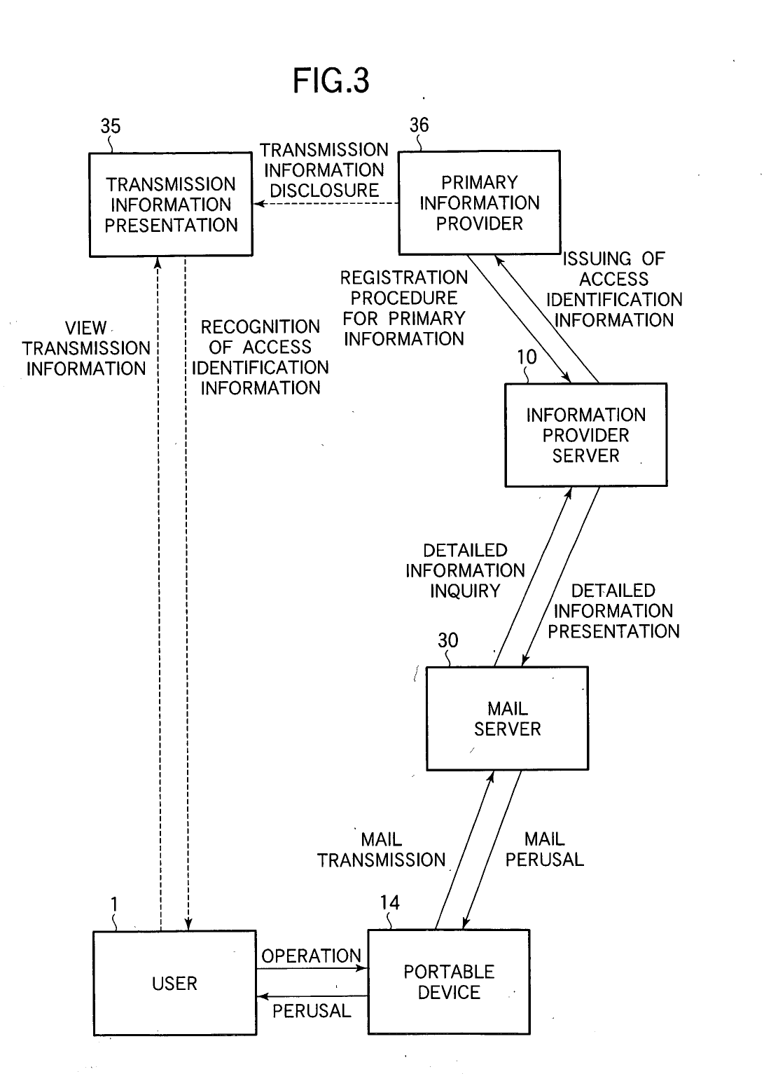

FIG. 3 is a flowchart showing the processing of the present embodiment.

First, a primary information provider 36 provides the essential content information (hereafter referred to as the primary information) for provision by the present embodiment, the so-called “contents”. The primary information provider 36 registers the primary information in the information-providing server 10. In order to enable smooth provision to the user 1, this registration is conducted in the form of unit information, or where necessary, a plurality of pieces of unit information. Then, at the time of this registration, an access identification information which differs for each piece of unit information is issued, and the unit information 11 is registered in the information-providing database 20, in a searchable format with the access identification information (information code) functioning as the search key information. Furthermore, at the time of the registration, the primary information provider 36 receives the access identification information issued for each registered unit information 11.

The access identification information comprises either the electronic mail address to be used as the electronic mail destination when requesting perusal of unit information by electronic mail, and the information code specifying the requested unit information sent in that electronic mail, or alternatively an electronic mail address incorporating the information code.

Moreover, when the primary information provider 36 provides no particular unit information to the information-providing server 10, but the user 1 sends an electronic mail to the information-providing server 10 based on transmission information, then there are occasions where the access identification information of that electronic mail, or the source of the electronic mail, namely the electronic mail address of the user 1, are stored in the user characteristics database 28, thereby collecting information relating to the user 1. For example, this describes the case where a campaign or the like is conducted, as described below.

In such a case, the primary information provider 36 need not register any particular unit information in the information-providing server 10. In this case, the primary information provider 36 can register with the information-providing server 10 for requesting the issuing of access identification information, the receiving of electronic mail from the user 1 using this access identification information, and the collecting of information relating to such electronic mail for the user characteristics database 28, and can also receive the access identification information.

However, even in the above type of case where a campaign is conducted, some form of electronic mail reply is still sent to the subscribing participant as a response to the subscription. In such a case, the reply content will be unit information, and so this can be registered in the information-providing database 20 of the information-providing server 10.

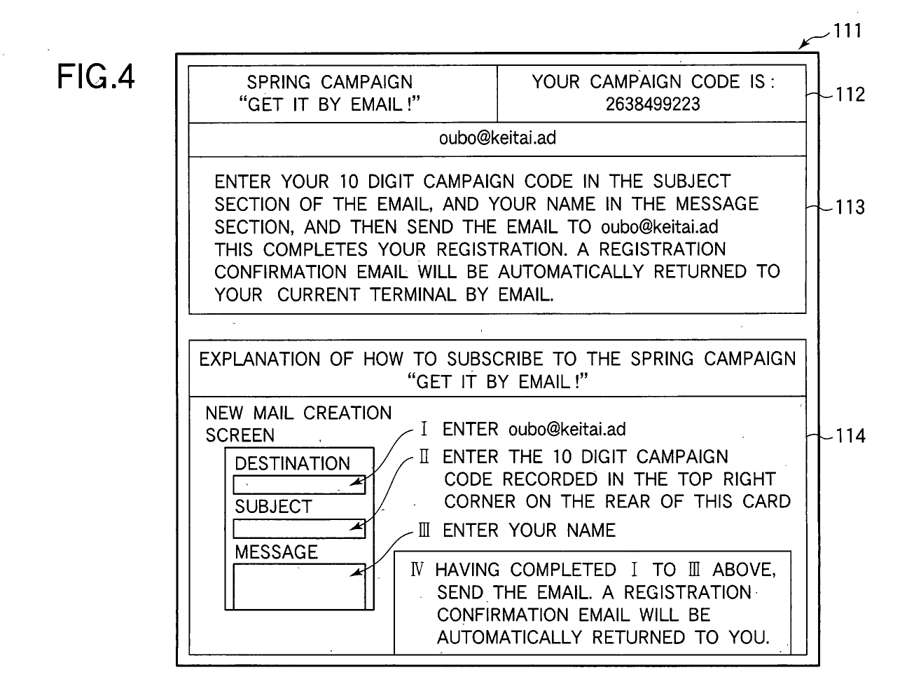

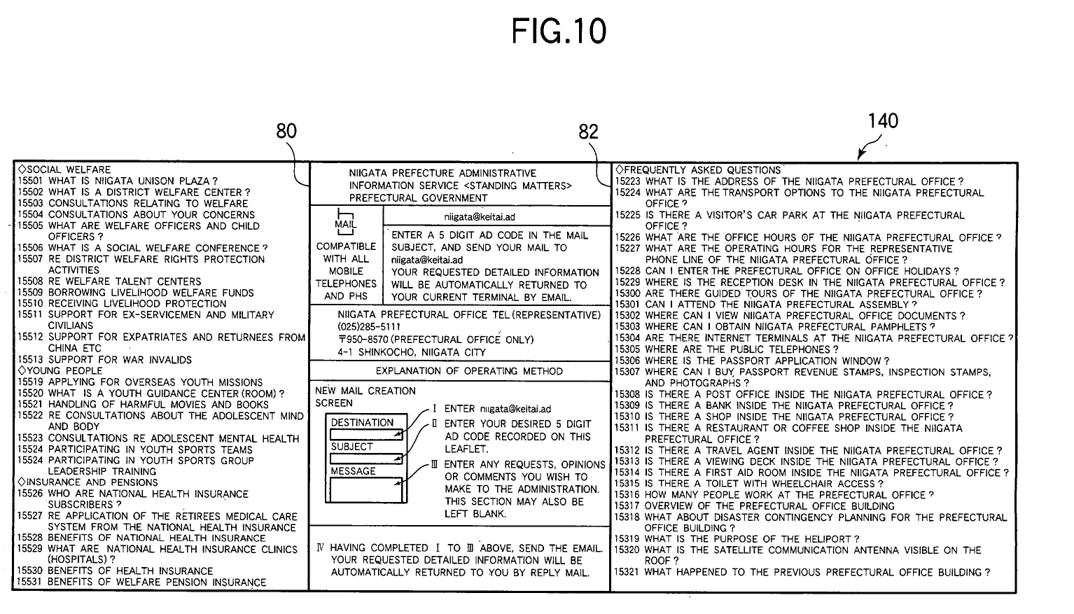

Subsequently, the primary information provider 36 discloses the access identification information, namely the corresponding mail address and the information code, to the display transmission medium displaying transmission information comprising either a list, or an outline, or a portion of the, corresponding unit information. This disclosure of transmission information becomes the transmission information presentation 35 shown in FIG. 3. This then, promotes recognition of the aforementioned access identification information to a user 1 who reads the transmission information and wishes to access the corresponding unit information. For example, the transmission information is presented in a form such as that shown in FIG. 4 or FIG. 10 (details of which are described below).

The present embodiment places no particular restrictions on this type of display transmission medium, and the display transmission medium may be a portable printed card medium, an electromagnetic wave medium, a publication medium, or a printed notice medium or the like. Moreover it is desirable that at least a portion of explanatory information describing how to send an electronic mail requesting desired unit information based on the access identification information is also disclosed in the transmission information presentation 35.

In the case where the user 1 wishes to use the transmission information presentation 35 to obtain more detailed information about some aspect of the transmission information, or in the case where the user wishes to participate in a type of subscription based on the transmission information, as described below, then the user 1 finds the access identification information showing the unit information corresponding with the sought information from within the transmission information presentation 35. Then, using the information terminal 14, and based on this access identification information, the user 1 sends an electronic mail from the mail server 30 requesting the desired unit information.

This mail is sent to the electronic mail address corresponding with the requested unit information, which is incorporated within the access identification information. Furthermore, the mail includes the information code specifying the requested unit information, and the information code may be provided within the “title” section of the mail, which is typically called the “subject”, “name” or “title” or the like within the actual electronic mail format, as shown in FIG. 4, or may also be inserted within the body of the mail message.

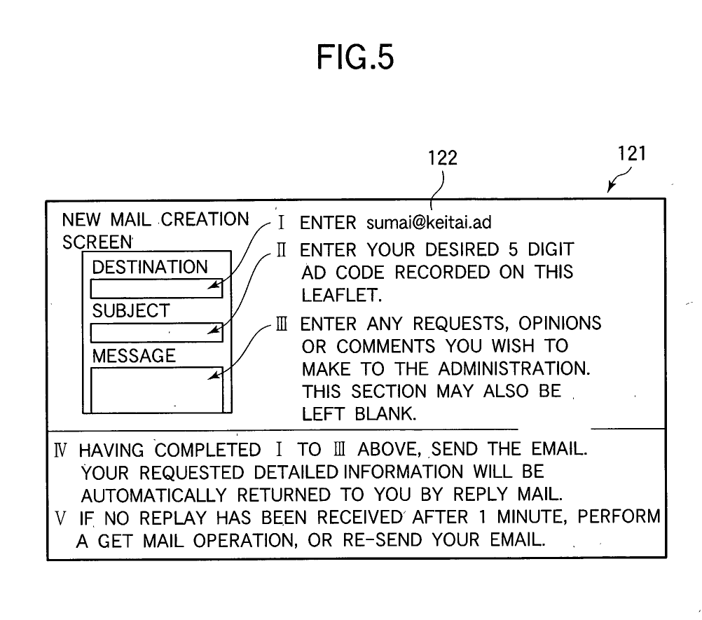

Furthermore, in the electronic mail address “sumai@keitai.ad” shown in FIG. 5, the section which appears before the @ mark, namely the “sumai” section, or alternatively a 5 digit number or the like, could also be used as the information code. In other words, the information code can be incorporated as one portion of the electronic mail address. Furthermore, the information code can also be input within the body of the mail message.

The aforementioned electronic mail is delivered to the mail server 24 of the information-providing server 10 as indicated by the electronic mail address corresponding with the requested unit information. Upon receipt of the mail, the mail server 24 sends the content of the mail message to the information exchange processing control device 22. At this time, the source of the mail, namely the electronic mail address of the user 1, is also read from the mail by the mail server 24 and sent to the information exchange processing control device 22.

In the case where the mail server 24 receives electronic mail via a plurality of different electronic mail addresses, then information specifying via which electronic mail address the mail was received is also sent from the mail server 24 to the information exchange processing control device 22. In the case where the electronic mail address incorporates the information code, then of course a plurality of electronic mail addresses must be set in the mail server 24.

The information exchange processing control device 22 determines the electronic mail address within the information-providing server 10 which received the mail, and also reads the information code incorporated within the mail. This electronic mail address and this information code makes up the access identification information. In addition, the information exchange processing control device 22 also recognizes the source of the mail, namely the electronic mail address of the user 1.

Then, in cases where no particular unit information is requested, but where the user 1 participates in the type of subscription described below based on transmission information, or furthermore in those cases where, as necessary, the user requests a piece of unit information based on the transmission information, then the information exchange processing control device 22 stores the access identification information from the mail, and the source of the mail, namely the electronic mail address of the user 1, in the user characteristics database 28.

Alternatively, in those cases where based on the transmission information the user 1 requests specific unit information, the information exchange processing control device 22 searches the information-providing database 20 for the unit information corresponding with the access identification information received from the user 1, and acquires that unit information. This acquired unit information is then sent from the information exchange processing control device 22 to the mail server 24. The mail server 24 then sends an electronic mail reply incorporating this acquired unit information to the mail server 30 of the source electronic mail address obtained from the electronic mail sent by the user 1. This electronic mail reply can be retrieved by connecting to the mail server 30 using the information terminal 14 used by the corresponding user 1, and the requested unit information incorporated within this electronic mail can then be read on the information terminal 14.

FIG. 4 is a diagram showing the disclosed form 111 of access identification information in a first example within the present embodiment.

In this first example, only a single electronic mail address and a single information code are used, and so these are disclosed together. The electronic mail address in this first example is the address “oubo@keitai.ad” shown in both the center and the upper section 112 of the diagram, and the information code is the campaign code shown in the top right section 113 of the diagram, namely “2638499223”. Furthermore, explanatory information relating to the procedure for sending an electronic mail requesting certain desired unit information based on the access identification information is inserted using the symbols I to IV.

FIG. 5 to FIG. 7 are diagrams showing the disclosed form of access identification information in a second example within the present embodiment.

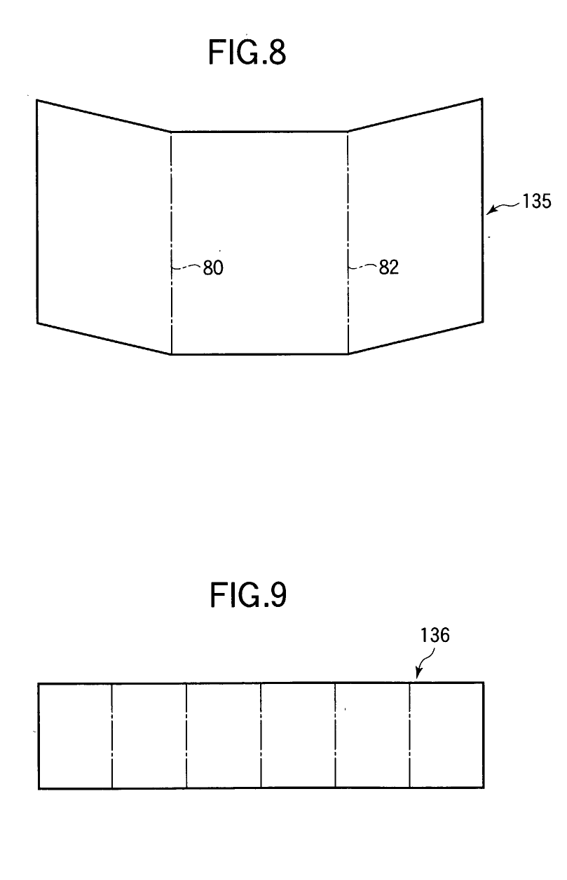

In the second example, for a single electronic mail address a plurality of information codes are used,-and these are disclosed on a plurality of screens or a plurality of pages. For example, in the case of a portable printed card 135, by folding the card 135 along the dashed lines 80 and 82 as shown in FIG. 8, a 3 page configuration can be produced, and in such a case if the printing is double sided, then the combination of the front and the back provides a total of 6 pages. Alternatively, in the case of a portable printed card 136, the card 136 could also be folded along a plurality of dashed lines as shown in FIG. 9, producing a plurality of pages.

As shown in FIG. 5, on the first page 121 of the second example, the electronic mail address is the address “sumai@keitai.ad” (denote 122) shown towards the top right of the diagram. Furthermore, explanatory information relating to the procedure for sending an electronic mail requesting certain desired unit information based on the access identification information is inserted using the symbols I to IV.

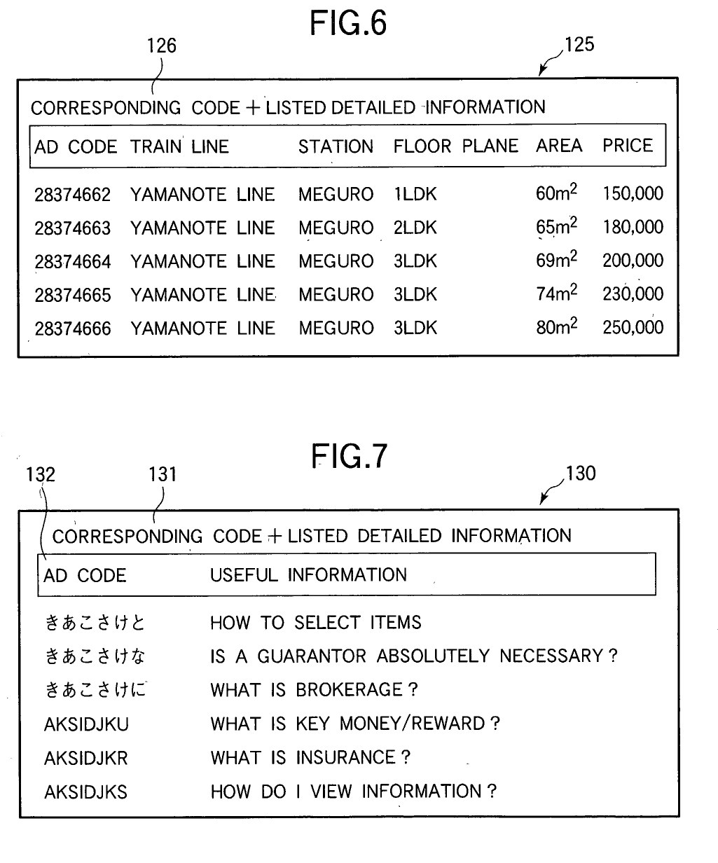

As shown in FIG. 6, on the second page 125 of the second example, information codes for unit information relating to various information items for real estate properties are the numbers such as “28374662” (denote 126) shown as corresponding codes or ad codes down the left hand side of the diagram. On the third page 130, information codes for various unit information comprising “useful information” relating to real estate properties are the codes such as “ [symbol] ” (KIAKOSAKETO) and “AKSIDJKU” shown as corresponding codes 131 or ad codes 132 down the left hand side of FIG. 7.

FIG. 10 to FIG. 13 are diagrams showing the disclosed form of access identification information in a third example within the present embodiment.

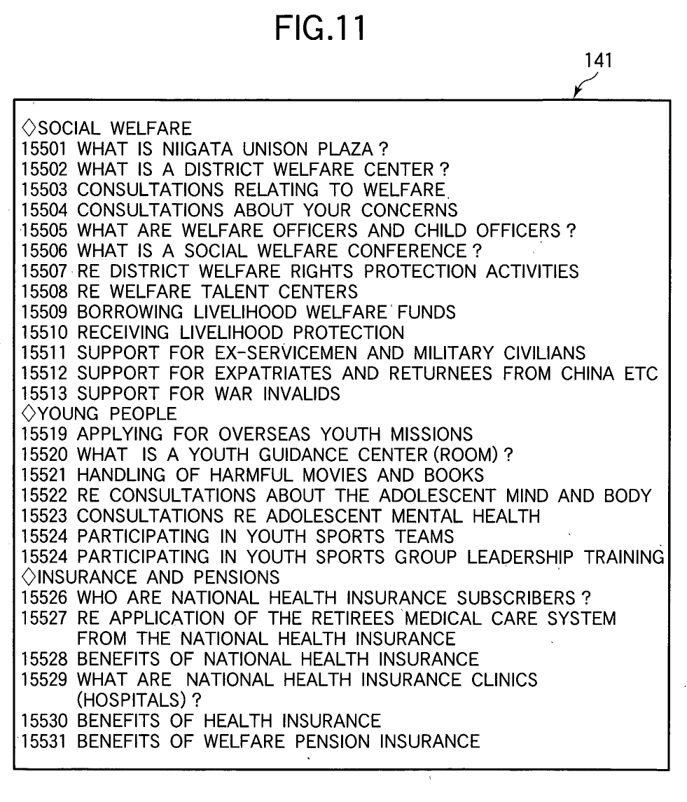

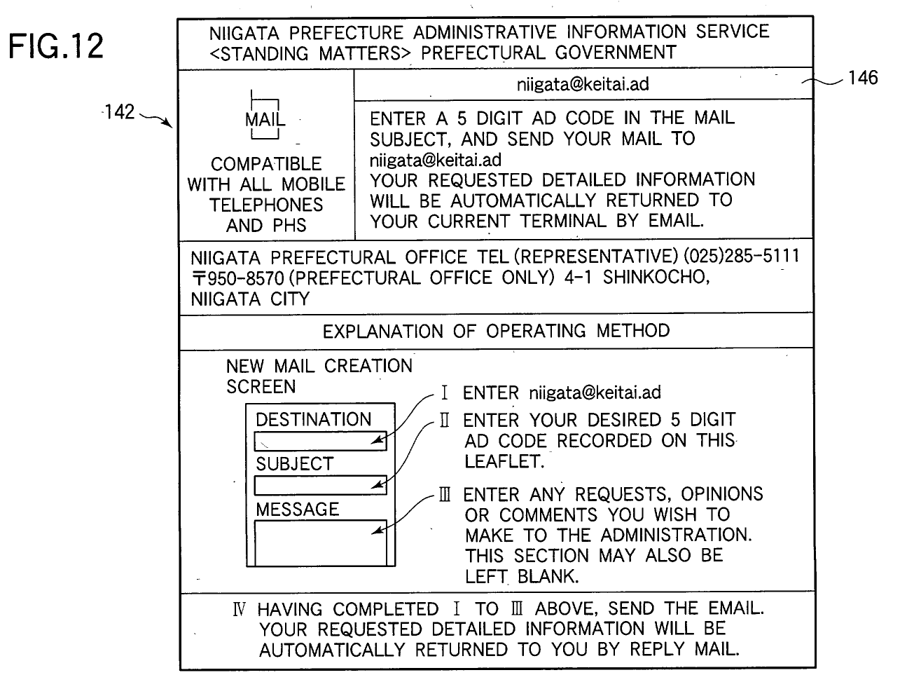

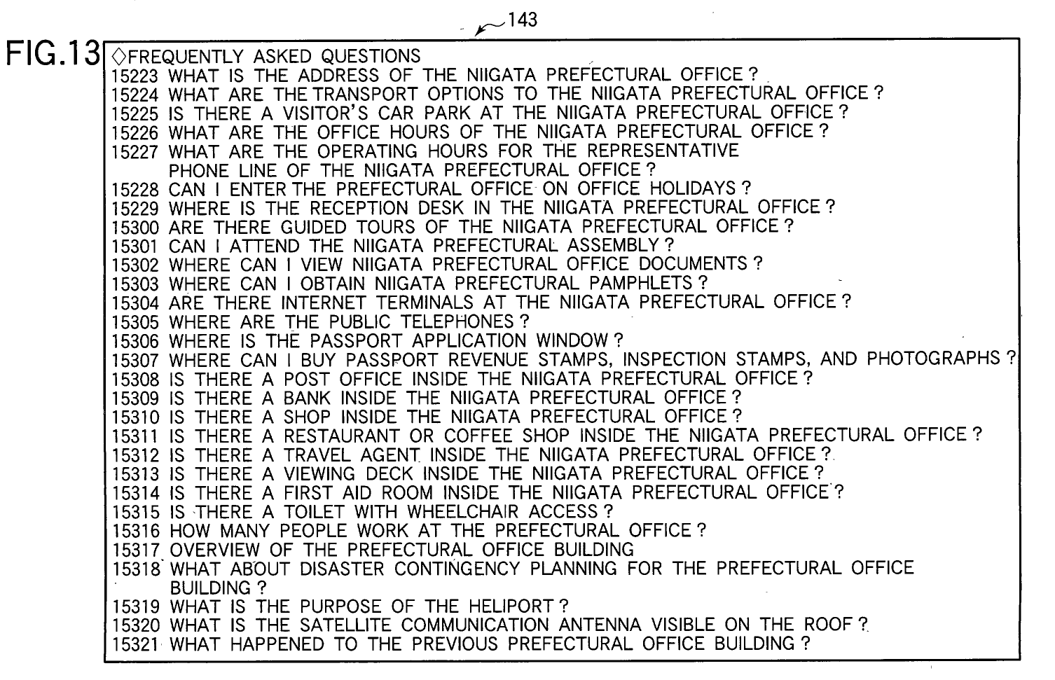

In the third example, for a single electronic mail address a plurality of information codes are used, and these are disclosed on a plurality of screens or a plurality of pages. This example is a portable printed card 140, and is a 3 page type configuration where the card 140 is folded along the solid lines 80, 82 in FIG. 10, in the same manner as the card of FIG. 8 was folded along the dashed lines 80, 82, with information then printed on the 3 pages of one side. The first page 141 to the left of the dashed line 80 is enlarged in FIG. 11, the second page 142 between the two dashed lines 80 and 82 is enlarged in FIG. 12, and the third page 143 to the right of the dashed line 82 is enlarged in FIG. 13.,

First, in the second page positioned in the middle of the third example, as shown in FIG. 12, the electronic mail address is the address “niigata@keitai.ad” shown in the upper section 146 of the diagram. Furthermore, explanatory information relating to the procedure for sending an electronic mail requesting certain desired unit information based on the access identification information is inserted using the symbols I to IV.

Next, in the left hand side first page of this third example, as shown in FIG. 11, information codes for various unit information comprising “useful information” relating to local public bodies are the codes “15501” to “15513 ”, “15519” to “15525” and “1552611 to “15531” shown down the left hand side of the diagram, and the titles of each of these pieces of unit information are printed to the right side of the corresponding information code and include “What is the Niigata Unison Plaza?” and “What is a district welfare center?”.

In addition, in the right hand side third page of this third example, as shown in FIG. 13, information codes for various unit information comprising “useful information” relating to local public bodies are the codes “15223” to “15321” shown down the left hand side of the diagram, and the titles of each of these pieces of unit information are printed to the right side of the corresponding information code and include “What is the address of the Niigata prefectural office?” and “What are the transport options to the Niigata prefectural office?”.

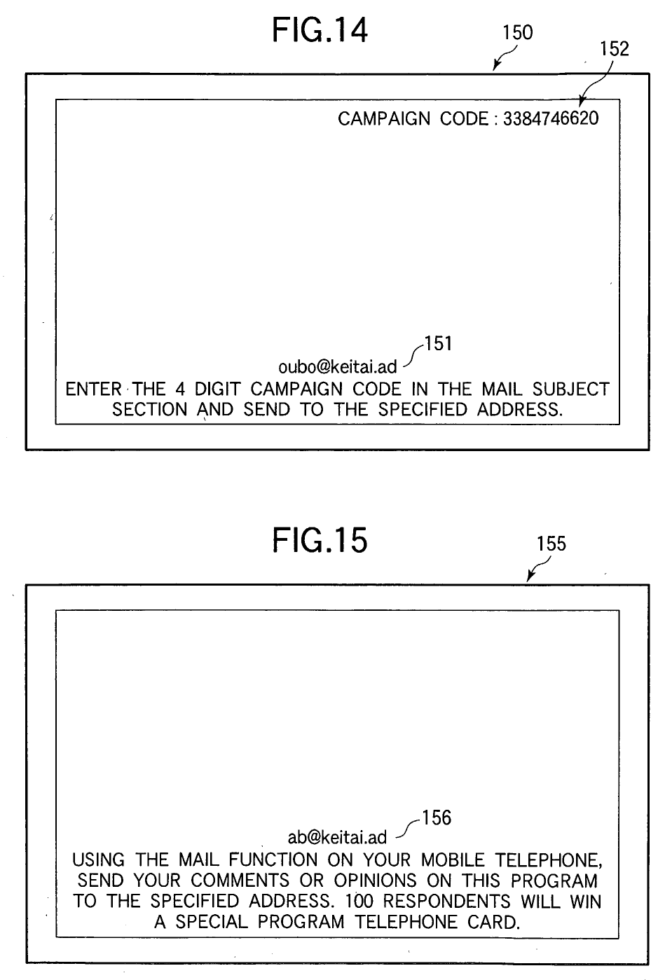

FIG. 14 is a diagram showing the disclosed form of access identification information in a fourth example within the present embodiment, assuming a television broadcast.

In the fourth example, only a single electronic mail address and a single information code is used, and so these are disclosed together. The electronic mail address in this fourth example is the address “oubo@keitai.ad” (denote 151) shown in the lower section of the diagram, and the information code is the campaign code “3384746620” (denote 152) in the upper right section of the diagram. This example represents a television broadcast, and the information shown in FIG. 14 is displayed on screen, whereas explanatory information relating to the procedure for sending an electronic mail requesting certain desired unit information based on the access identification information is voiced by an announcer.

FIG. 15 is a diagram showing the disclosed form of access identification information in a fifth example within the present embodiment, assuming a television broadcast.

In the fifth example, an electronic mail address utilizes a plurality of information codes which are presented by screen displays or voice announcements during a program. The electronic mail address in this fifth example 155 is the address “ab@keitai.ad” (denote 156) in the central lower section of the diagram. This example represents a television broadcast, and the information shown in FIG. 15 is displayed on screen, whereas explanatory information relating to the procedure for sending an electronic mail requesting certain desired unit information based on the access identification information, together with the information codes, are presented during the program by screen displays or voice announcements by an announcer.

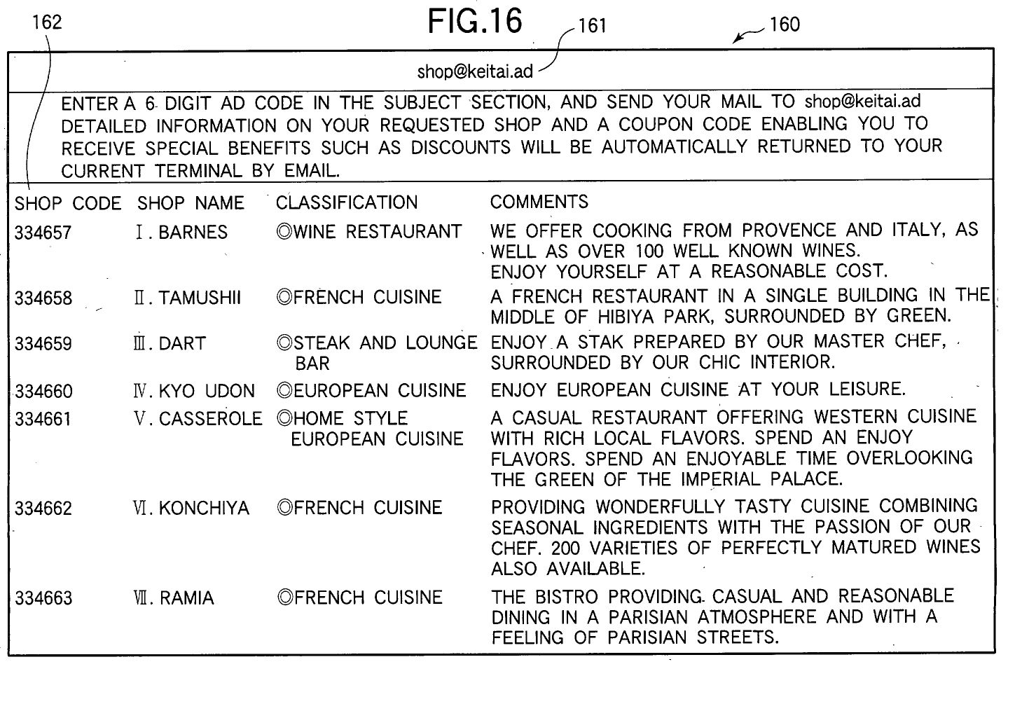

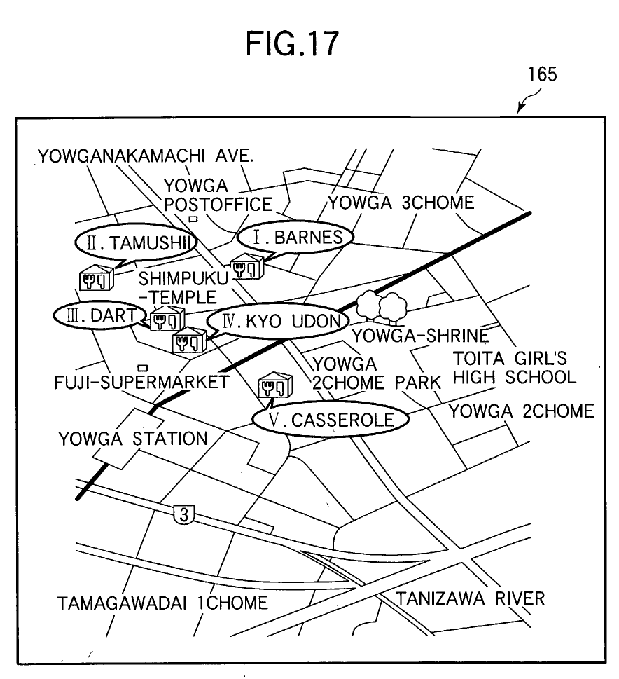

FIG. 16 and FIG. 17 are diagrams showing the disclosed form of access identification information in a sixth example within the present embodiment.

In the sixth example 160, a single electronic mail address utilizes a plurality of information codes, and these are displayed on the same page. In other words, as shown in FIG. 16, on the first page the electronic mail address is the address “shop@keitai.ad” shown in the upper section of the diagram. Furthermore, each unit information is information relating to an individual shop, and the information codes for these pieces of unit information are the shop codes 162 such as “334657” shown down the left hand side of the diagram. In addition, on this same page, explanatory information relating to the procedure for sending an electronic mail requesting certain desired unit information based on the access identification information is inserted beneath the aforementioned electronic mail address.

Furthermore, in this present example, a map 165 such as that shown in FIG. 17 is also attached, and can be used as a reference when selecting unit information relating to the shops. The symbols I to VTI of FIG. 17 match the symbols used before each of the shop names in FIG. 16.

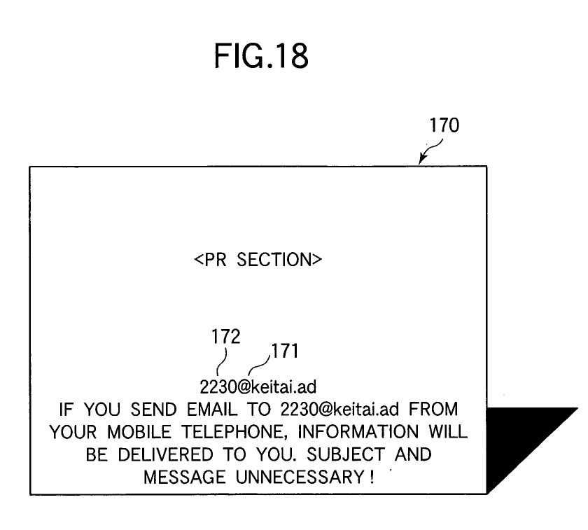

FIG. 18 is a diagram showing the disclosed form of access identification information in a seventh example within-the present embodiment.

In the seventh example 170, the information code 172 is provided as one portion of the electronic mail address. Specifically, this example 170 is an advertisement in which a number is set as the information code 172 and then provided in the portion of the electronic mail address before the @ mark (denote 171).

Hereafter is a description of the embodiment, using the first example through to the seventh example as examples.

First is a description of the combination with a printed medium.

Firstly, the term printed medium refers to distributed or sold cards, leaflets, post cards, pamphlets, magazines, newspapers and folded flyers, as well as posted media such as posters, signs, billboards, notice boards and outdoor advertising boards (hereafter referred to as posted printed media). Furthermore, a particular example of the aforementioned cards is a portable printed card.

The information to be presented is displayed as a list of contents on this type of printed medium. During the conversion to a list of contents, the information may also be divided into topics. In addition, an information code is attached to each piece of information-in the list of contents on the printed medium. The outward appearance of this list of contents is as shown in the previous diagrams of FIG. 6, FIG. 7, FIG. 10, FIG. 11, FIG. 13 and FIG. 16.

The information codes may be numbers, alphabet letters, hiragana letters, katakana letters, Chinese characters, or a combination thereof, and there are no specific restrictions.

In addition, a destination mail address is also printed on the printed medium. The insertion of this mail address is as shown in FIG. 4, FIG. 5, FIG. 10, FIG. 12, FIG. 14 to FIG. 16 and FIG. 18.

In addition, a system explanatory text is also printed on the printed medium. In particular, at least a portion of the explanatory information describing how to send an electronic mail requesting certain desired unit information based on the access identification information comprising this type of mail address and information code, is printed. The insertion of this explanatory information is as shown in FIG. 4, FIG. 5, FIG. 10, FIG. 12, FIG. 16 and FIG. 18.

Furthermore, the portable printed card of this embodiment is a type of card which can be always carried around, to make best use of the characteristics of mobile telephones which are always, carried around. The card is of a size which will fit in a wallet or a season ticket holder, and can incorporate a creative layout of the access identification information according to the present invention. In addition, by increasing the number of usable pages and increasing the printable area by folding the card as shown in FIG. 8 and FIG. 9, the amount of information can also be increased.

This card will not function in isolation, but rather is a card which will only function in combination with an information terminal. In this regard, it can be said that this is a new concept not seen until now. Furthermore, by making the printed information itself function as an advertisement, this card can also be applied to use as a media medium.

The information which can be provided as unit information of the present invention includes information for commercial transmission such as sales or service provisions, and “useful” information which offers convenience to users. Printing “useful” information aims to make the user carry the card around as a convenient stored record.

Providing this type of unit information can promote more frequent information requests from the user. Furthermore, when the present embodiment provides unit information, the access identification information of the provided information is stored, in user units, in the user characteristics database 28 of the information-providing server 10. The user characteristics database 28 operates in conjunction with the information exchange processing control device 22 and the mail server 24.

In the user characteristics database 28, traces are left such as “who (the mail address of the user who requested information) requested what unit information, and when”.

Furthermore, by storing the access identification information of the information provided to users in this manner, information on individual users, and marketing information which can be used in subsequent business undertakings can be collected,, and the popularity of each of the listed information codes can be learned. In addition, the mail addresses of users can also be learned. In the present embodiment, the electronic mail addresses of users are also stored in the user characteristics database 28.

For example, in the case of real estate properties, by including the railway line, the station name, the floor area and the price in the list of contents when providing information, and then storing the access identification information when information is provided, assumptions can be made about the real estate preferences of the users who requested the information. Furthermore, when providing information on weather forecasts, by information coding the districts requested, and then storing the access identification information, estimations can be made of the movements of any particular user, provided the districts for which weather forecast information were requested are saved.

Next is a description of the type of information terminals 14 which can be used with the present embodiment.

The information-terminal 14 of the present embodiment may be any information terminal or the like which has an electronic mail function. Suitable examples include an IP compatible mobile telephone, a PDA, a car computer (car navigation system), a PC, or an IP compatible function such as L-mode on a normal telephone.

The user looks at the individually created printed medium, and requests detailed information, equating to unit information, for information of interest. At this time, the user activates the electronic mail function, and then during the-mail creation stage, inputs the electronic mail address specified as the access identification information of the present invention, inputs the information code to be requested in the “subject” section, and sends the mail with the “message” section of the mail empty.

In this case, the information input into the “subject” and the information input into the “message” may be interchanged. In the case where the information code is incorporated within the electronic mail address, these inputs are also unnecessary. It is also possible to get the user to input information such as name, sex, birth date, opinions, comments or claims within the “message” section. In such cases, explanatory text must be added to the printed medium.

Following transmission of the electronic mail, the information-providing server 10 automatically conducts a search based on the access identification information, and the unit information providing detailed information of the access identification information requested by the user is sent automatically by reply mail.

Furthermore, this embodiment can also be applied to campaigns and the like. In other words, as shown in FIG. 4 and FIG. 14, the information code becomes a campaign code. When the embodiment is applied to a campaign, the electronic mail address of a subscriber is automatically attached when the subscriber transmits the electronic mail. Consequently, subscribers can be specified without the tiresome requirement of inputting data for the subscriber, and so the system provides convenience for both the user and the promoter.

For example, in a merchandise sales campaign or the like, an individual code known only to the purchaser is attached either inside the merchandise or on a seal or label. By simply sending this individual code to the indicated electronic mail address, the purchaser of the merchandise completes a primary subscription. At the time of subscription, the information-providing server 10 may immediately determine a win or a lose result. Alternatively, a point system may be used. The win or lose result, or the number of points may also be automatically conveyed to the subscriber by electronic mail.

In a further example, the bar code on a wine label could be sent to a specified electronic mail address. At this point, if the 13 digit bar code is input into either the subject or the message section of the mail, then information relating to that product, such as the production location, the brand, and the best way of drinking the wine, is sent as a reply.

In addition, the mail addresses acquired by using the present embodiment in a campaign or the like can be used for activities such as announcements to companies using electronic mail. In such cases, a user may wish to refuse unnecessary mail. If so, a concealed code is included in the message section of the sent mail. Those users who wish to refuse subsequent mail transmissions can indicate a desire to refuse further mail by simply replying to the received electronic mail.

Next is a description of combinations with media other than printed media.

The present embodiment can be utilized outside of printed media, in combination with media such as television or radio for example, by providing a portion of the explanation relating to the usage method as a voiced explanation. By combination with the present embodiment, the mail addresses of viewers or listeners can be acquired, which enables a link to be made to the provision of electronic mail services to viewers or listeners.

For example, combinations with electromagnetic wave media are possible. An electromagnetic wave medium is defined to include television broadcasts and radio broadcasts, for example. Furthermore, related media include television games and promotion videos and the like.

Public television and radio broadcasts are one way media. By combining these media with a real time mail reply function, two way characteristics can be added to one way media. By achieving such two way characteristics, other functions can also be realized, such as obtaining feedback or requests from viewers or listeners. Furthermore, at the same time, the mail addresses of viewers or listeners can be acquired, and so these acquired mail addresses can be utilized in subsequent program promotions.

Information is always flowing in public broadcasts, and so it is difficult to display a list of contents in the same manner as a printed medium. Consequently, keywords are used instead of information codes. This situation is described in relation to the replacement of weather forecast information on radio or television.

In the weather forecasts on public broadcasting, the district segments are large, and often result in forecasts for only the major cities. This is because even if pin point measurement data (at the local city, ward, town or village level) exists, program editing time restrictions mean that the weather information cannot be provided for narrowed down districts. In such cases, for example, the fact that specified viewers or listeners can be provided with weather information for a specific narrowed down district by sending an electronic mail incorporating information showing the district for which a weather forecast is required to an electronic mail address which has been previously advertised, can be publicized as unit information according to the present invention.

In such a case, the name of a city or ward, or a station name in the district for which the weather forecast is required-is entered into the “subject” section of an electronic mail, and the electronic mail requesting the weather information is then sent to the specified electronic mail address. The procedure for sending the electronic mail is explained either via voiced explanations or screen images. The user, namely the viewer or listener who sees or hears the explanation takes out a mobile telephone and sends an electronic mail in accordance with the explanations. Subsequently, the information-providing server 10 replies with weather information obtained by an automatic search, providing the user 1 with weather information for the desired district.

The procedure for sending the electronic mail, in the case of television, is conveyed by voiced explanations and subtitling on the television screen. In radio broadcasting, the entire procedure is conveyed by voice.

As an application of the present invention, a new type of user service can be realized through combination with an electromagnetic wave medium, in fields such as real estate, travel, employment opportunities or second hand vehicles, where a region must be-narrowed down from a large quantity of information. Furthermore, a new relational structure is also possible between an information provider and a user, using the mail function of mobile telephones.

Next is a description of the application of the present invention to a television game, as an example of a different medium.

For example, a concealed code within a television game could be used as an information code of the present invention. For example, during playing of the television game, the concealed code could be designed to appear at a specific scene, or at a specific point level. Provided the user can discover the concealed code, then if that code is sent to the specified address by electronic mail, additional value can be added to the game by providing hints for more enjoyable game playing, or adding some type of special feature or benefit.

By applying information codes in this manner within a television game, the embodiment of the present invention can be utilized, and by combining the use of electronic mail via a mobile telephone, a new level of television game enjoyment can be provided to the user, and moreover the provider of the game can ascertain information on factors such as the preferences of the user and the degree of utilization of the game. Furthermore, the provider can also acquire the mail address of the game user 1, and consequently can establish a link with the game user at any time by sending an electronic mail.

Next is a description of a promotion video as a medium.

A subscription code for requesting a variety of benefits by electronic mail can be added to a promotion video such as a movie in the form of an information code of the present invention. Examples of these benefits include a campaign subscription or discount coupons. Furthermore, if the subscription code is set differently for each video title, then which video was watched can also be clearly determined. In addition, the subscription code can also be used as a subscription number for a campaign or the like.

As follows is a description of an information code according to the present embodiment.

First is a description of a campaign code.

When a user participates in a campaign, if an electronic mail is sent to the subscription destination mail address using the campaign code, then in addition to a reply informing the user that the subscription has been received, an individually issued campaign code is also sent as a reply. This code may comprise numbers or letters from the alphabet or a combination of the two.

For example, in the case where all those users who requested information are set as campaign participants, then a registration confirmation code is inserted as a portion of the reply information. These registration confirmation codes are issued so that there is no duplication between participants, and the user with the subsequently drawn winning number becomes a winner.

Furthermore, in order to limit the campaign to purchasers of merchandise, the campaign code for subscription can be printed in a location only accessible to the purchaser, or similarly the method of participation described in a location only accessible to the purchaser. Furthermore in the case of a television broadcast, in order to limit the campaign to the viewers at that time, the campaign code can be disclosed during the broadcast, thereby achieving a campaign based only on the viewers. In either case, the campaign code need only be inserted into the space provided for the subject or the message and the mail then sent. In those cases where the campaign code is incorporated within the electronic mail address, nothing need be input into, the subject and message spaces.

Next is a description of a coupon code.

In the case where a benefit is requested for an eating or drinking establishment or a shop selling merchandise, then when an electronic mail is sent to a specified electronic mail address, a coupon code is automatically returned as a reply. This coupon code comprises either numbers, letters of the alphabet or a combination of the two, and the issued coupon code and the mail address of the applicant who requested the coupon code is retained at the service provider end (shop), and upon visiting the shop, the applicant need only convey the coupon code, or where necessary his or her mail address, to be identified as a person due special privileges. In order to restrict the time, the period or the services available, the issued code can also be issued with a combination of this type of information. Furthermore, a coupon participation code used to request a coupon code can be publicized using printed media or electromagnetic wave media. At this time, by introducing a concept where the identified mail address and the request code differ depending on the printed media or electromagnetic wave media used to publicize the coupon system, an identification can be made automatically of which medium initiated a request.

Next is a description of a survey code.

As follows, a description is given of an example where a simple survey entitled “survey of television viewing time” is conducted using a printed medium or an electromagnetic wave medium. The viewing time responses in this survey are (1) 1 to 3 hours, (2) 4 to 8 hours, (3) 9 hours or more, and (4) less than 1 hour. The above question and multiple choice responses, and the electronic mail address to which the response should be sent is publicized via a printed medium, or voiced or screen based instructions. The respondent inputs his or her own single response in the subject section (in the case of a plurality of questions and a plurality of responses, one response is added to the message section), and then sends the electronic mail to the specified mail address. The mail server which receives the mail performs a database totalization, and can calculate a result instantaneously, as well as sending a thank you reply, or PR or a campaign message to the mail address of the participant.

Next is a description of a commercial code.

Commercials for a large number of companies are conducted using electromagnetic wave media. During such commercials, a free dial number is disclosed for inquiries and requests for information, and this service is then realized by utilizing an automatic mail reply and a classification code. For example, in the case of a radio program, when an electronic mail is sent to the mail address of the radio station, then if a commercial code is inserted in the subject section, a mail reply is returned which includes information about that company such as announcements, a link to the website, or a telephone number or the like. Furthermore, if the mail address is set to an address which enables services to be specified, then the user can request details about a desired product by simply entering the address.

Examples of other information codes include address codes, company codes for describing companies on the stock market, map codes comprising longitude and latitude data, telephone numbers, postal numbers, and G codes used for identifying television programs.

Next is a description of a method of applying the present embodiment to newspapers and magazines.

By inserting past articles and features into a published magazine using a format comprising article headline+corresponding code, a user who sees the list can obtain any desired article or feature by using the automatic reply function and simply sending an electronic mail to the specified mail address. At such a time, the corresponding code for the desired article needs to be simply entered in the subject (title) section or the message section of the mail. The increase in the volume of accessible information expands the level of convenience for the user, whereas the publisher is able to raise the value of the magazine by improving both the reader response and the level of supplementary services offered by the magazine, and at the same time also acquire the mail addresses of purchasers, which can then be used in subsequent publication publicity.

In such cases, by making this service a fee based service, the publisher can also resell previous articles and features. At this time, to specify only fee paying users for example, an information corresponding code is inserted in the subject section, and an ID or a password issued by the publisher is entered in the message section before sending the mail. Then, the server can perform an authentication by comparing the sent mail address with the issued ID, and at the same time the user is provided with the convenience of being able to carry out the authentication and the information request simultaneously.

At the same time, request codes can also be combined with advertisements in the magazine. For example, a specific electronic mail address of access identification information of the present invention is assigned in advance and advertised for a certain weekly magazine called “ABC weekly”. Furthermore, the information code of the access identification information of the present invention is set as the type of advertisement code described below. Namely, the advertisement code comprises the publication date of the weekly magazine and a company code, or more specifically the final two digits of the year, two digits for the month and two digits for the day of the publication date, and a further three digits for a company code (client code).

For example, for the weekly magazine with a publication date of Apr. 27, 2001, the advertisement code for a company “BCD car company” with a company code of 001 would be 010427001, the advertisement code for a company “CDE hairdressing company” with a company code of 002 would be 010427002, the advertisement code for a company “DEF foodstuffs company” with a company code of 003 would be 010427003, and the advertisement code for a company “EFG drinks company” with a company code of 004 would be 010427004.

The user 1 sends mail to a specified electronic mail address, and by simply changing the advertisement code entered in the subject section of the mail, is able to request detailed information relating to an advertisement or link information to associated home pages.

In addition, as described below, an addition function can be set within the aforementioned information-providing server 10.

For example, conditions for searching similar unit information could be added to the information codes allocated by the transmission information presentation 35, and a user 1 accessing each of the aforementioned pieces of unit information 11A, 11B . . . could also be provided with other similar information searched using the search conditions incorporated within the information code, so that for example, the unit information 11B of an adjacent information code is also provided to the user 1.

In addition, a plurality of information codes could be set for a single piece of unit information, so that these information codes indicate a plurality of different display transmission media such as newspapers and magazines for example, and are also registered in the aforementioned information-providing server 10 as search key information, and then when a user 1 accesses the unit information using the same procedure as that described above, a detection can be made of which display transmission medium, namely newspapers or magazines, enabled the user 1 to acquire the information code. Consequently, a judgment can be made as to the effectiveness of the advertising.

Furthermore, in the same manner as the so-called banner advertising used on mobile telephones, with each access from a user 1, a advertising fee can be charged to the sponsor based on the detected advertising effect (number of accesses).

In examples described below, a mobile telephone 14A or a PHS 14B, each having electronic mail function, a small portable personal computer 14C, a PDA 14F, or a car-mounted mobile computer 14H is used as the portable information terminal 14.

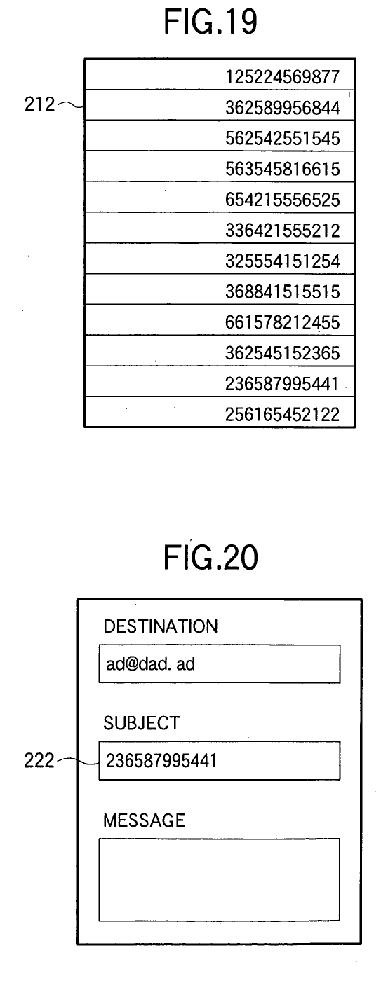

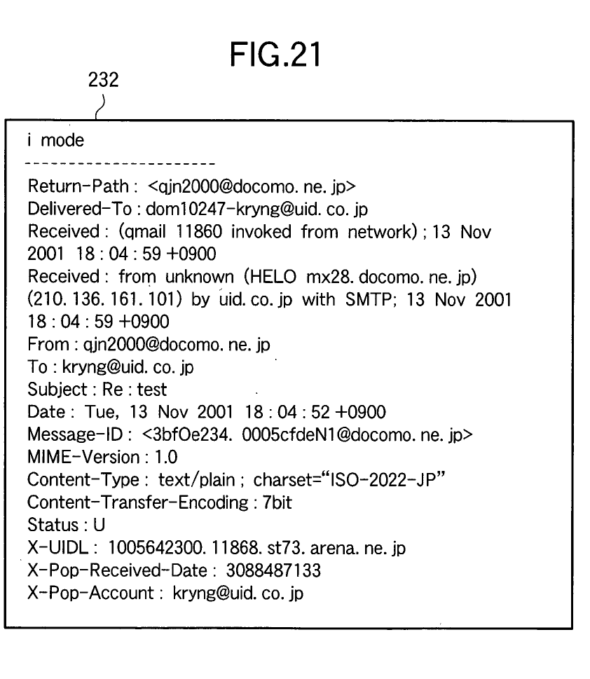

FIG. 19 is a diagram showing information codes forming a part of the access identification information according to an eighth example of the present embodiment. FIG. 20 is a diagram showing one example of an electronic mail entry incorporating the access identification information according to the eighth example. FIG. 21 is a diagram showing one example of header information in electronic text of the electronic mail according to the eighth example.

As shown in FIG. 19, the eighth example employs 12-digit information codes 212, which form part of the access identification information and are stored in the information-providing database 20. As shown in FIG. 20, the user 1 enters the information code in the “subject” section 222 of an electronic mail on the information terminal 14. Header information 232 as shown in FIG. 21 is attached to so produced text of the electronic mail when the text is transmitted to the information-providing server 10 via the internet 12 in the form of electronic text created based on the internet protocols and other criteria. Also, the header information includes as a reply address the electronic mail address of the user 1 such as the character string “<qjn2000@docomo.ne.jp>” shown on the second line in FIG. 21. Such a reply address serves as one type of information to help identify the user 1.

This example takes advantage of such header information.

In this example, pre-issued information codes are stored in the information-providing database 20. If electronic mail text is received from the user 1, the information-providing database 20 in the information-providing server 10,is searched through for the code put down in the subject section of the electronic mail to determine if that code has previously been issued as an information, code. Meanwhile,, the above-described reply address included in the header information is retrieved in the information-providing server 10 to distinguish between individual users 1 by means of the reply address. The number of times that the user 1 has sent electronic mail to the information-providing server 10 is added up for each user 1.

In this example, depending on the total number of times calculated upon receipt of the electronic mail from the user 1, the unit information to be sent from the information-providing server 10 to the user 1 at a later point of time is selected or edited.

In this example, for example, the information code to form part of the access identification information is printed on wrapping material used to wrap merchandise or on a piece of paper placed within the wrapping, so as to be obtained by the user 1 as a proof of purchase. Subsequently, the user 1 sends the obtained information code via electronic mail to the information-providing server 10 in accordance with the present example. Upon receipt of the electronic mail, the information-providing server 10 calculates the total number of times that it has received electronic mail from each of the users 1, who are, as described above, distinguishable from one another by means of the reply addresses. The resulting total number can be used as an earned point of the user in offering various commercial services. The user 1 may be informed by the information-providing server 10 of his/her earned point, which is the current total, as the unit information to which the present invention is applied.

In the present example, the information code to form part of the access identification information is not limited to those expressed only in numbers as shown in FIG. 19. For example, it may be expressed in alphabet letters, Chinese characters, hiragana letters, or a combination thereof. Likewise, the number of digit's is not limited to that shown in FIG. 19.

In the present example, the type of information contained in the header information for identifying the user 1 is not limited to the above-described reply address. Any other type of information in the header information that can be used to identify the user 1 may also be used.

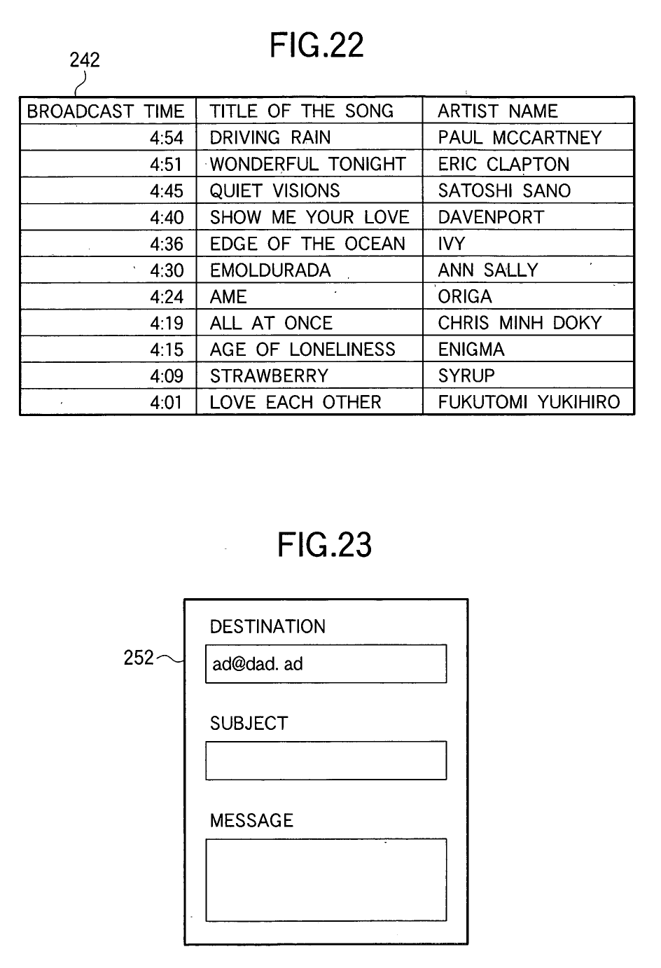

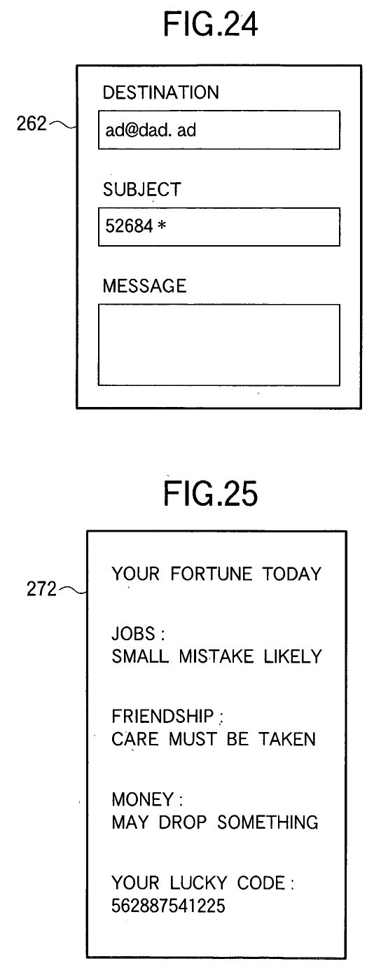

FIG. 22 is a diagram showing information codes forming part of the access identification information in a ninth example of the present embodiment. FIG. 23 is a diagram showing one example of an electronic mail entry according to the ninth example. FIG. 24 is a diagram showing one example of header information in electronic text of the electronic mail according to the ninth example.

The ninth example is directed to the music broadcast on radio or cable broadcasts and the inserted music broadcast on television. In short, it enables provision of unit information in the form of the title and artist name of a song heard by a user 1 when, by making use of the present invention, a request for the unit information is made to the information-providing server 10 via electronic mail from the information terminal 14 while the song is still on the air. In this example, the time when the song heard by the user 1 was broadcast is specified to allow the user 1 to specify the song. This is accomplished by using time information included in the electronic mail that the user 1 has sent to the information-providing server 10.

As shown in FIG. 22, 24-hour representations of broadcast time are used in this example as part of the access identification information of the present invention and function as the information codes 242 forming part of the access identification codes. The unit information for each piece of the access identification information includes the title and artist name of the song broadcast at that broadcast time. Such, information codes and unit information can be created from schedule information of various music broadcast programs. Once created, the information codes and the unit information are stored in the information-providing database 20.

When creating electronic mail 252 using the information terminal 14 as shown in FIG. 23, the user, 1 does not enter the information code. Header information as shown in FIG. 24 is attached to the electronic mail text created in this manner when the electronic mail is transmitted to the information-providing server 10 via the internet 12 in the form of electronic text created based on the internet protocol and other criteria. This header information includes at least one piece of time information. Examples of such time information include time that the electronic mail was created by the user 1, time that the electronic mail was transmitted, and time that the electronic mail passed through a proxy server.

In the present example, at least one of these pieces of time information is used as an equivalent of the information code corresponding to the broadcast time of the information-providing database 20 while the music is on the air. A time delay caused by the time that it takes the user 1 to create the electronic mail, as well as the clock errors of the information terminal 14 and of the proxy server in the internet 12, may be taken into account, and in this regard, the plurality of the pieces of time information included in the header information may be referred.

In the present example, a database is created by using the 24-hour representations of broadcast time obtained from the schedule information of various music broadcast programs to serve as the information code, which forms part of the access identification information of the present invention, and by using the title and artist name of the song broadcast at that broadcast time as the unit information for the access identification information corresponding to that broadcast time. The database created in this manner is stored in the information-providing database 20. Upon receipt of the electronic mail text from the user 1, by using one or more pieces of the time information included in the header information of the electronic mail text as an equivalent of the information code that forms part of the access identification information, the information-providing database 20 is searched through for the information code of that broadcast time by the information-providing server 10. As a result, the corresponding unit information including the-title and the artist name of the song is found. The information-providing server 10 then sends the obtained unit information to the user 1.

According to the present example, the user 1 can obtain as unit information the title and the artist name of a song that he/she hears being broadcast on radio, cable, or television broadcasts either-in private or as a background music in shops or restaurants.

As described above, when it is desired to inquire the title and the artist name of a song as unit information while the song is on the air, an equivalent of the information code corresponding to the broadcast time is obtained from the header information. Thus, the user 1 enters only the electronic mail address of the information-providing server 10 as a destination of the electronic mail and leaves the subject and the body sections of the electronic mail blank.

In one variation of the present example, the title and artist name of a song that has been broadcast at a given time point may be inquired as the unit information after broadcasting of the song.

In order to make it possible to obtain the unit information also after the song has been broadcast, the aforementioned given time point is entered in the subject or the body section of an electronic mail as an equivalent of the information code corresponding to the broadcast time. The user 1 enters the electronic mail address of the information-providing server 10 as an electronic mail destination and sends the electronic mail to the information-providing server 10. Upon receipt of the electronic mail, the information-providing server 10 searches through the information-providing database 20 based on the equivalent of the information code corresponding to the broadcast time entered in the subject or the body section of the electronic mail and finds the title and the artist name of the song for the unit information that corresponds to the broadcast time. The information server 10 then sends the obtained unit information to the user 1.

In the present example and in the above-described variation of the present example, the electronic mail address of the information-providing server 10 may differ for each broadcast station so that the broadcast station that broadcasts the song can be distinguished from the others based on the electronic mail address. Alternatively, a single electronic mail address may be used for different broadcast stations, and the broadcast station that broadcasts the song may be distinguished from the others based on the code entered in the subject or the body section of the electronic mail.

FIG. 24 is a diagram showing one example 262 of the electronic mail entry including access identification information according to a tenth example of the above-described embodiment.

In this example, a character “*” or a character “#” is assigned a special function and is used as a special character to be entered together with the information code that forms part of the access identification information, as the subject of the electronic mail. For example, in FIG. 24, “52684” is the information code and “*” that immediately follows “52684” is the special character.

In the present example, the character “*” is assigned a special function to indicate a desire of the user 1 that he/she does not want to receive further mail later on. On the other hand, the character “#” is assigned a-special function to indicate that the user 1 accepts further mail delivery at a later point.

The special character is not limited to the characters “*” and “#” and may be any other characters. Similarly, the meaning assigned to each special character is not limited to the aforementioned indication of desire concerning the later mail delivery.

FIG. 25 is a diagram showing one example 272 of the manner for displaying unit information according to an eleventh example of the above-described embodiment.

In this example, a reply user code, which differs for each electronic mail reply, is attached to the unit information transmitted to the user 1 via an electronic mail reply according to the present invention. For example, “562887541225” in FIG. 25 designated as “lucky code” serves as the reply user code.

No particular limitation is imposed on the reply user code or its purpose. For example, a lottery may be played on a later day by choosing from the reply user codes in a commercial campaign, and a special prize or special service may be awarded to the user 1 who won the winning number.

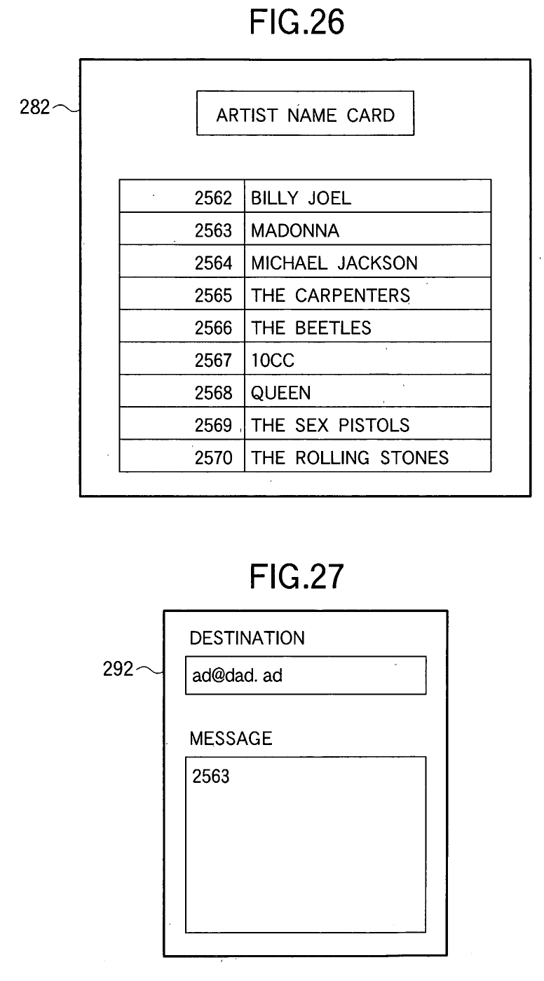

FIG. 26 is a diagram showing the disclosed form 282 of the information code according to a twelfth example of the above-described embodiment. FIG. 27 is a diagram showing one example 292 of an electronic mail entry incorporating the information code according to the twelfth example.

In this example, as shown by dotted lines in FIG. 1, electronic mail is directly sent to the information-providing server 10 from the information terminal 14 without using the internet 12. In this example, a request for the unit information from the information terminal 14 of the user 1 as well as provision of the unit information from the information-providing server 10 in accordance with the present invention is implemented through a closed network that does not include the internet 12.

No particular limitation is imposed on the closed network. For example, examples of the closed network include short message service (SMS) and the like.

In the present example, a printed card format is used to present the information codes as shown in FIG. 26. In this example, the unit information is provided in the form of audio data and thus can be reproduced as sound on the information terminal 14. Each piece of the unit information is associated with a four-digit information code as shown in FIG. 26.

When requesting a specific piece of unit information, the user 1 enters a four-digit code of the corresponding information code in the body section of an electronic mail as shown in FIG. 27. In addition, a corresponding electronic mail address is entered and the electronic mail is transmitted to the information-providing server 10 to request a desired piece of the unit information.

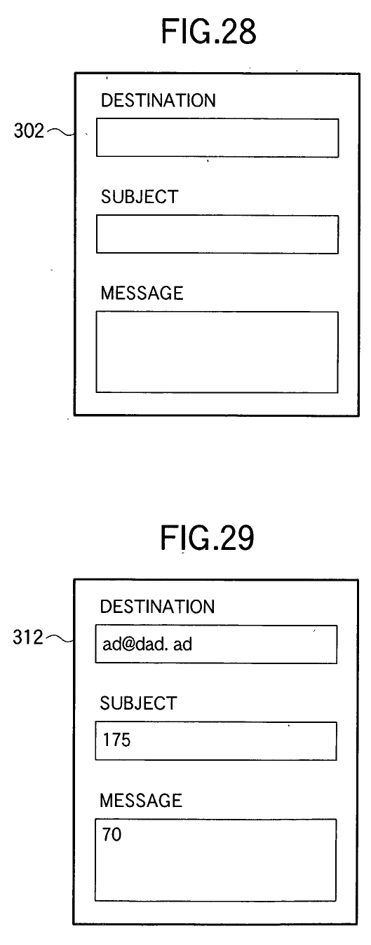

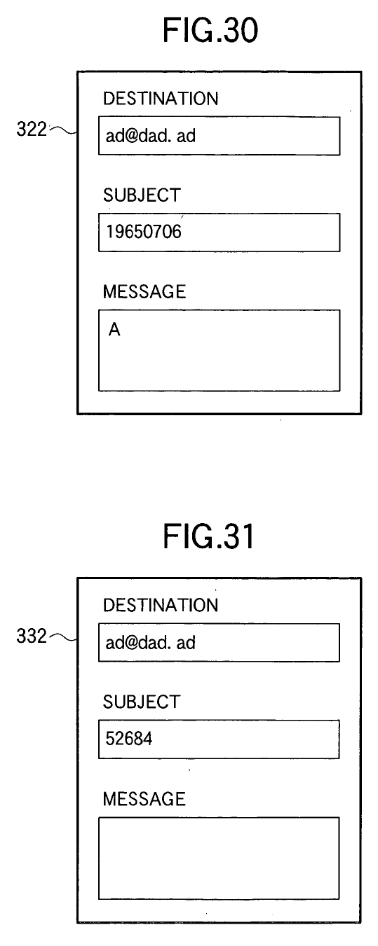

FIG. 28 is a diagram showing one example 302 of an electronic mail entry according to a thirteenth example of the above-described embodiment. FIG. 29 is a diagram showing a first example 312 of the electronic mail entry incorporating an information code according to the thirteenth example. FIGS. 30 through 33 are diagrams showing a second through a fifth example 322, 332, 342 352 of the electronic mail entry incorporating an information code according the thirteenth example, respectively.

In this example, the user 1 creates an electronic mail on the display screen of the information terminal 14 as shown in FIG. 28 and sends it to the information-providing server 10 and, in return, the user 1 receives on the information terminal 14 a specific piece of unit information sent from the information-providing server 10 and is thereby provided a specific type of service.

For example, a calculator function service is provided in FIG. 29. In FIG. 29, the height of a person of interest is entered in the subject section of the electronic mail 312 and the weight of the person in the body section of the electronic mail, and the electronic mail is sent to the information-providing server 10. In return, the information-providing server 10 sends back to the information terminal 14 of the user 1 a piece of unit information in the form of a result of the calculation of the ideal body fat percentage for a person with the height and the weight.

In FIG. 30, a fortune-telling service is provided. In FIG. 30, the birth date of a person of interest is entered in the subject section of the electronic mail 322 and the blood type of the person in the body section. For example, in FIG. 30, a birth date “Jul. 6, 1965” is entered as “19650706” and “A” is entered as a blood type. Such electronic mail is sent to the information-providing server 10. In return, the information-providing server 10 sends back to the information terminal 14 of the user 1 a piece of unit information in the form of text about fortune-telling of a person with the birth date and the blood type.

In FIG. 31, a lottery service is provided. In FIG. 31, a five-digit number -that the user guessed to be a winning number is entered in the subject section of the electronic mail 332 as an entry for a lottery. For example, in FIG. 31, “52684” is, entered. Such electronic mail is sent to the information-providing server 10. In return, the information-providing server 10 sends back to the information terminal 14 of the user 1 a piece of unit information in the form of text describing whether the entry has won a prize or what prize he/she has won.

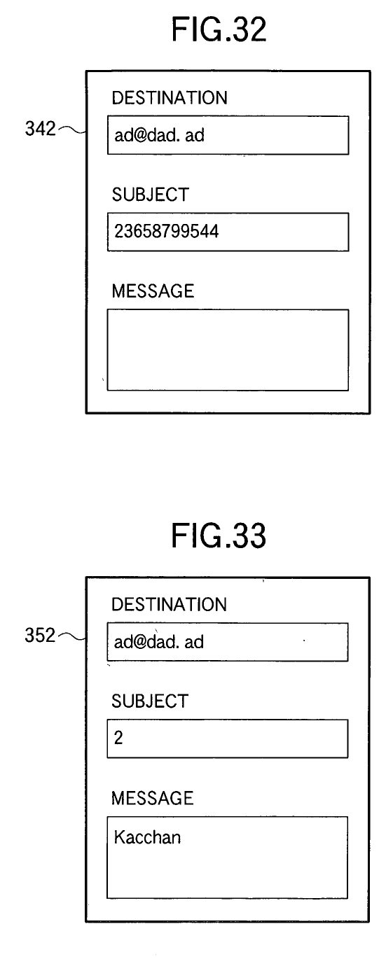

In FIG. 32, another type of lottery service is provided. In FIG. 32, an eleven-digit code, which is provided on merchandise or distributed materials and is hidden under a sticker or the like, serves as-an entry number for a lottery. This entry code is entered in the subject section of the electronic mail 342. For example, in FIG. 32, “23658799544” is entered. Such electronic mail is sent to the information-providing server 10. In return, the information-providing server 10 sends back to the information terminal 14 of the user 1 a piece of unit information in the form of text describing whether the code has won a prize or what prize he/she has won.

In FIG. 33, a quiz answer service is provided. The user 1 enters his/her answer to a quiz, which is separately printed, in the subject section of the electronic mail 352 and his/her nickname in the body section. The nickname is used when the winners are publicly announced on a later day. For example, in FIG. 33, “2” is entered in the subject section as the answer and “Kacchan” in the body section as a nickname. Such electronic mail is sent to the information-providing server 10. In return, the information-providing server 10 sends back to the information terminal 14 of the user 1 a piece of unit information in the form of text describing whether the answer was correct or the like.

In this example, the user 1 may use only one electronic mail address when he/she sends electronic mail to the information-providing server 10 for individual services. Alternatively, a different electronic mail address may be used, for example, for each magazine, newspaper or broadcasting medium that advertises the service. In this manner, the number that the service has been accessed can be counted for each electronic mail address and thus, data can be obtained that help know the effect or efficiency of the advertisement of each medium.

Aside from those described above, the present example can offer a variety of services. While, in providing these services, the subject and the body sections of an electronic mail sent by the user 1 serve as a region for entering a piece of information that instructs the information-providing server 10 to select a piece of the unit information to be provided and to edit the unit information, they can also be considered as a region for entering an “instruction command” for remote-controlling the services and the functions of the information-providing server 10. In other words, it can be considered that each information code functions as if it were an “instruction command.”

Alternatively, a plurality of information codes may be divided by a space or other special characters such as “;” or “:” and are entered into the subject or the body section of the electronic mail for transmission so that the plurality of information codes function as if they were a plurality of “instruction commands.” These special characters are referred to as divisional special characters.

Using an electronic mail function of a device such as a mobile telephone with an internet browser, target unit information can be acquired by simply sending an electronic mail to an information-providing server using an electronic mail address, and entering a simple information code, providing a high level of convenience to the user.

What is claimed is:

1. A method of providing information, wherein
group information comprising a plurality of pieces of unit information is registered in advance in an information-providing server with access identification information for individually specifying and requesting such unit information for supply for perusal by a user functioning as search key information, and said access identification information comprises either one of an electronic mail address which functions as an electronic mail destination from said user and an information code which differs for each of said pieces of unit information, and an electronic mail address incorporating said information code,
that said access identification information is disclosed on a display transmission medium displaying any one of a list, an outline, and a portion of corresponding unit information, and recognition of said access identification information is promoted to a user reading said transmission information and requesting corresponding unit information, and
that when said user sends an electronic mail incorporating said information code specifying requested unit information to said information-providing server at said electronic mail address corresponding with said requested unit information, an electronic mail address showing a source of said electronic mail transmission is acquired from said electronic mail together with said specified information code.

2. A method of providing information, wherein
group information comprising a plurality of pieces of unit information is registered in advance in an information-providing server with access identification information for individually specifying and requesting such unit information for supply for perusal by a user functioning as search key information, and said access identification information comprises either one of an electronic mail address which functions as an electronic mail destination from said user and an information code which differs for each of said pieces of unit information, and an electronic mail address incorporating said information code,
said access identification information is disclosed on a display transmission medium displaying any one of a list, an outline, and a portion of corresponding unit information, and recognition of said access identification information is promoted to a user reading said transmission information and requesting corresponding unit information, and
when said user sends an electronic mail incorporating said information code specifying requested unit information to said information-providing server at said electronic mail address corresponding with said requested unit information, unit information corresponding with said access identification information comprising said electronic mail address and said information code is provided from said information-providing server to said user via an electronic mail reply to a source electronic mail address acquired from said electronic mail sent by said user.

3. The method of providing information according to claim 1, wherein
a plurality of different access identification information are set for each single piece of said unit information, and said plurality of different access identification information is disclosed separately on a plurality of different display transmission media, and also registered in said information-providing server as search key information.

4. The method of providing information according to claim 2, wherein
a plurality of different access identification information are set for each single piece of said unit information, and said plurality of different access identification information is disclosed separately on a plurality of different display transmission media, and also registered in said information-providing server as search key information.

5. The method of providing information according to claim 1, wherein
results of unit information requests from a user using said access identification information are,detected for each access identification information.

6. The method of providing information according to claim 3, wherein
said plurality of different access identification information are allocated to, and disclosed using each type of said display transmission medium, and results of unit information requests from a user are detected for each type of display transmission medium.

7. The method of providing, information according to claim 4, wherein
an advertising fee is calculated based on a result of a request from said user detected for each of said plurality of access identification information.

8. The method of providing information according to claim 5, wherein
an advertising fee is calculated based on a result of a request from said user detected for each of said plurality of access identification information.

9. The method of providing information according to claim 1, wherein
said display transmission medium-comprises at least one of a portable printed card medium, an electromagnetic wave medium, a publication medium, and a printed notice medium.

10. The method of providing information according to claim 1, wherein
said information code comprises at least one of a campaign code, a coupon code, a survey code, a commercial code, an address code, a company code, a map code, a telephone number, a postal number, and a G code.

11. The method of providing information according to claim 1, wherein
information for identifying said user included in header information of said electronic mail sent from said user is extracted and used in said information-providing server.

12. The method of providing information according to claim 2, wherein
information for identifying said user included in header information of said electronic mail sent from said user is extracted and used in said information-providing server.

13. The method of providing information according to claim 1, wherein
time information included in said electronic mail sent from said user is extracted and used in said information-providing server.

14. The method of providing information according to claim 2, wherein
time information included in said electronic mail sent from said user is extracted and used in said information-providing server.

15. The method of providing information according to claim 1, wherein
said information code is entered in a subject or a body section of said electronic mail sent from said user, and a special character that is assigned a special function immediately follows said information code.

16. The method of providing information according to claim 2, wherein
said information code is entered in a subject or a body section of said electronic mail sent from said user, and a special character that is assigned a special function immediately follows said information code.

17. The method of providing information according to claim 1, wherein
a plurality of said information codes are entered in a subject or in a body section of said electronic mail sent from said user with a predetermined divisional character placed between the plurality of said information codes.

18. The method of providing information according to claim 1, wherein
a plurality of said information codes are entered in, a subject or in a body section of said electronic mail sent from said user with a predetermined divisional character placed between the plurality of said information codes.

19. The method of providing information according to claim 1, wherein
a reply user code is attached to said unit information that is provided to said user via an electronic mail reply, said reply user code differing for each electronic mail reply.

20. The method of providing information according to claim 2, wherein
a reply user code is attached to said unit information that is provided to said user via an electronic mail reply, said reply user code differing for each electronic mail reply.

21. The method for providing information according to claim 1, wherein
said electronic mail sent by said user to said information-providing server and said electronic mail reply thereto are directly transmitted without using the internet.

22. The method for providing information according to claim 2, wherein
said electronic mail sent by said user to said information-providing server and said electronic mail reply thereto are directly transmitted without using the internet.

23. An information providing system comprising:
an information-providing server wherein group information comprising a plurality of pieces of unit information is registered in advance in said information-providing server with access identification information for individually specifying and requesting such unit information for supply for perusal by a user functioning as search key information, and moreover said access identification information comprises either one of an electronic mail address which functions as an electronic mail destination from the user and an information code which differs for each of said pieces of unit information, and an electronic mail address which incorporates said information code, and which upon receipt of an electronic mail from said user incorporating said information code specifying a requested unit information, via said electronic mail address corresponding with said requested unit information, acquires from said electronic mail an electronic mail address showing a source of said electronic mail transmission, together with said specified information code; and
a display transmission medium for disclosing said access identification information together with a display of transmission information comprising any one of a list, an outline, and a portion of corresponding unit information, and promoting recognition of said access identification information to a user reading said transmission information and requesting corresponding unit information.

24. An information providing system comprising:
an information-providing server wherein group information comprising a plurality of pieces of unit information is registered in advance in said information-providing server with access identification information for. individually specifying and requesting such unit information for supply for perusal by a user functioning as search key information, and moreover said access identification information comprises either one of an electronic mail address which functions as an electronic mail destination from the user and an information code which differs for each of said pieces of unit information, and an electronic mail address which incorporates said information code, and which upon receipt of an electronic mail from said user incorporating said information code specifying requested unit information, via said electronic mail address corresponding with said requested unit information, provides unit information corresponding with said access identification information comprising said electronic mail address and said information code to said user via an electronic mail reply to a source electronic mail address acquired from said electronic mail sent by said user; and
a display transmission medium for disclosing said access identification information together with a display of transmission information comprising any one of a list, an outline, and a portion of corresponding unit information, and promoting recognition of said access identification information to a user reading said transmission information and requesting said unit information.

25. An information-providing server comprising:
an information-providing database wherein group information comprising a plurality of pieces of unit information is registered in advance in an information-providing server with access identification information for individually specifying and requesting such unit information for supply for perusal by a user functioning as search key information, and moreover said access identification information comprises either one of an electronic mail address which functions as an electronic mail destination from said user and an information code which differs for each of said pieces of unit information, and an electronic mail address which incorporates said information code; and
an information exchange processing control device which upon receipt from said user, via said electronic mail address corresponding with requested unit information, of an electronic mail incorporating said information code specifying requested unit information, provides unit information corresponding with said access identification information comprising said electronic mail address and said information code to said user via an electronic mail reply to a source electronic mail address acquired from said electronic mail sent by said user.

26. A portable printed card medium, wherein.
of group information comprising a plurality of pieces of unit information for supply for perusal by a user, access identification information comprising an electronic mail address which functions as an electronic mail destination for individually specifying and requesting required unit information, and an information code which differs for each of said pieces of unit information, is disclosed and printed in a display of transmission information comprising any one of a list, an outline, and a portion of corresponding unit information,
at least a portion of explanatory information for sending an electronic mail requesting desired unit information based on said access identification information is printed, and
recognition of said access identification information is promoted to a user reading said transmission information and requesting corresponding unit information.
